(19) United States
(12) Patent Application Publication
(10) Pub. No.: US 2024/0278554 A1
(43) Pub. Date: Aug. 22, 2024

(54) INK JET SYSTEM

(71) Applicant: SEIKO EPSON CORPORATION, Tokyo (JP)

(72) Inventors: Toshiro MURAYAMA, FUJIMI-MACHI (JP); Tomonaga HASEGAWA, MATSUMOTO-SHI (JP); Akira MIYAGISHI, SHIOJIRI-SHI (JP); Nobuaki ITO, SUWA-SHI (JP)

(21) Appl. No.: 18/444,357

(22) Filed: Feb. 16, 2024

(30) Foreign Application Priority Data
Feb. 21, 2023 (JP) 2023-024931

(51) Int. Cl. B41J 2/045

(52) U.S. Cl. CPC B41J 2/04541; B41J 2/04581; B41J 2/04588

(57) ABSTRACT

An ink jet system includes: a first subsystem including at least a first recording apparatus and a first processing apparatus, the first recording apparatus being equipped with a first head unit that ejects ink and being configured to execute a recording operation on a recording medium, the first processing apparatus performing data processing for causing the first recording apparatus to execute the recording operation; a second subsystem including at least a second recording apparatus and a second processing apparatus, the second recording apparatus being equipped with a second head unit that ejects ink and being configured to execute a recording operation on a recording medium, the second processing apparatus performing data processing for causing the second recording apparatus to execute the recording operation; a first server connected to both the first subsystem and the second subsystem; and a second server connected to the first server.

The present application is based on, and claims priority from JP Application Serial Number 2023-024931, filed Feb. 21, 2023, the disclosure of which is hereby incorporated by reference herein in its entirety.

### BACKGROUND

### 1. Technical Field

The present disclosure relates to an ink jet system.

### 2. Related Art

In the related art, a recording apparatus such as an ink jet printer that is equipped with a head unit that ejects ink and executes a recording operation on a recording medium such as printing paper has been provided. For example, JP-A-2021-84388 discloses a recording apparatus that applies a waveform of a drive signal to a drive element provided in a head unit in order to eject ink.

In regard to the above-mentioned related art, it is conceivable to connect either a recording apparatus or a processing apparatus that executes data processing to a server, and cause the server to store a program related to the recording operation. However, when the program stored in the server cannot be executed, such as the program stored in the server is being updated, the recording apparatus may not be able to execute the recording operation.

### SUMMARY

According to an aspect of the present disclosure, there is provided an ink jet system including: a first subsystem including at least a first recording apparatus and a first processing apparatus, the first recording apparatus being equipped with a first head unit that ejects ink and being configured to execute a recording operation on a recording medium, the first processing apparatus performing data processing for causing the first recording apparatus to execute the recording operation; a second subsystem including at least a second recording apparatus and a second processing apparatus, the second recording apparatus being equipped with a second head unit that ejects ink and being configured to execute a recording operation on a recording medium, the second processing apparatus performing data processing for causing the second recording apparatus to execute the recording operation; a first server connected to both the first subsystem and the second subsystem; and a second server connected to the first server.

### BRIEF DESCRIPTION OF THE DRAWINGS

FIG. 1 is a schematic diagram showing a configuration example of an ink jet system according to a first embodiment.

FIG. 2 is a diagram showing an example of a configuration of an in-cloud server.

FIG. 3 is a diagram showing an example of a configuration of an in-cloud server.

FIG. 4 is a diagram showing an example of a configuration of an administrator server.

FIG. 5 is a diagram showing a configuration of a mobile terminal.

FIG. 6 is a diagram showing a configuration of a processing apparatus.

FIG. 7 is a schematic diagram illustrating an example of a configuration of an ink jet printer.

FIG. 8 is a block diagram showing a configuration example of the ink jet printer.

FIG. 9 is a cross-sectional view showing a configuration example of a head chip.

FIG. 10 is a diagram showing functions of the ink jet system.

FIG. 11 is a flowchart showing a series of operations of the ink jet system when a recording operation according to new condition information is executed.

FIG. 12 is a diagram for describing an example of control information according to the first embodiment.

FIG. 13 is a diagram for describing processing in step SD2 and step SD6.

FIG. 14 is a diagram for describing a request to access data and an update request for a program in the ink jet system.

FIG. 15 is a diagram showing functions of an ink jet system according to a second embodiment.

FIG. 16 is a diagram showing functions of a recording system according to a first modification example.

FIG. 17 is a schematic diagram showing a configuration example of an ink jet system according to a second modification example.

FIG. 18 is a diagram showing an example of a configuration of an accumulation server.

FIG. 19 is a diagram showing functions of the ink jet system.

FIG. 20 is a diagram for describing a request to access data and an update request for a program in the ink jet system.

FIG. 21 is a diagram showing functions of an ink jet system according to a third modification example.

FIG. 22 is a diagram for describing an example of control information according to a fourth modification example.

### DESCRIPTION OF EMBODIMENTS

Embodiments for carrying out the present disclosure will be described below with reference to the drawings. Here, in each drawing, the dimensions and scales of each section are appropriately different from the actual ones. In addition the embodiments described below are preferred specific examples of the present disclosure, and therefore, various technically preferable limitations are given, but the scope of the present disclosure is not limited to these forms unless there is a description to the effect that the present disclosure is particularly limited in the following description.

### 1. First Embodiment

### 1-1. Overview of Ink Jet System 10

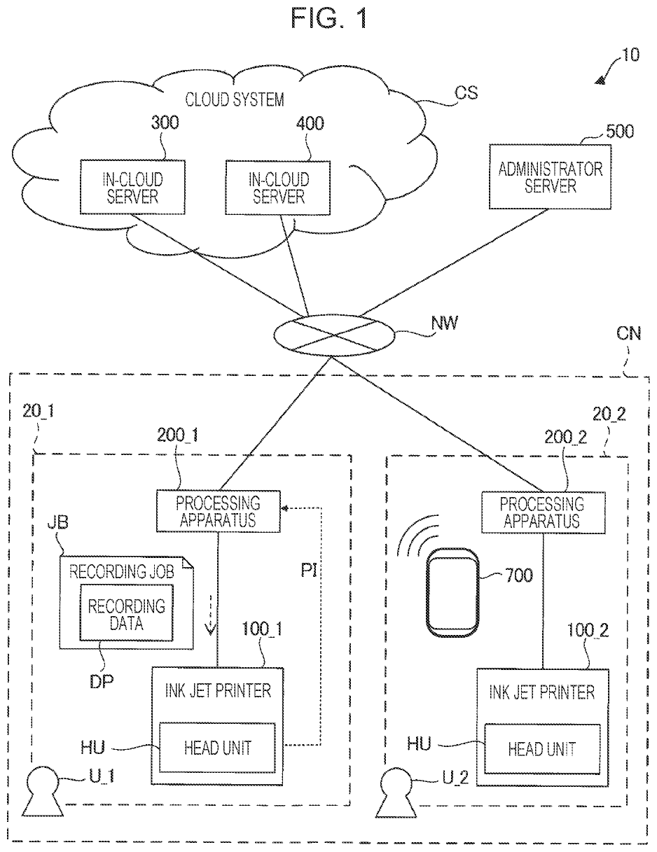

FIG. 1 is a schematic diagram showing a configuration example of an ink jet system 10 according to a first embodiment. The ink jet system 10 is a system that manages a recording system 20 that performs recording on a recording medium PP, which will be described later, using an ink jet method. In the example shown in FIG. 1, the ink jet system 10 includes an administrator server 500, an in-cloud server 300, an in-cloud server 400, and an in-house system CN. The in-house system CN is a system constructed in a company that uses the ink jet system 10. Hereinafter, the company that uses the ink jet system 10 may be referred to as a “user company”. The in-house system CN includes ink jet printers 100_1 and 100_2, processing apparatuses 200_1 and 200_2, and a mobile terminal 700.

Here, the ink jet printers 100_1 and 100_2 are apparatuses provided by a manufacturer of the ink jet printers 100_1 and 100_2. In the following description, the ink jet printers 100_1 and 100_2 may be collectively referred to as the ink jet printer 100 without distinguishing between them. The ink jet printer 100 is a liquid ejecting apparatus that ejects ink, which is an example of a liquid. A manufacturer of the ink jet printer 100 is a company that manufactures the ink jet printer 100. The manufacturer of the ink jet printer 100 may be referred to as a “printer manufacturer”. Each of the ink jet printers 100_1 and 100_2 may be provided by the same printer manufacturer or may be provided by different printer manufacturers. However, head units HU incorporated in the ink jet printers 100_1 and 100_2 are provided by a manufacturer of the head units HU. A manufacturer of the head units HU is a company that manufactures the head units HU. Hereinafter, the manufacturer of the head units HU may be referred to as a “head manufacturer”. The head manufacturer manages the ink jet system 10. The printer manufacturer receives the provision of the head unit HU from the head manufacturer, and manufactures the ink jet printer 100 by incorporating the provided head unit HU into the ink jet printer 100. The ink jet printer 100 is an example of a “recording apparatus”.

In the following, a recording system 20_i may be described for each integer i from 1 to 2. The recording system 20_i includes at least an ink jet printer 100_i and a processing apparatus 200_i. In the following description, recording systems 20_1 and 20_2 may be collectively referred to as a recording system 20 without distinguishing each of the recording systems 20_1 and 20_2. It can also be said that the in-house system CN includes the recording system 20_1 and the recording system 20_2. The recording system 20_1 and the recording system 20_2 are installed, for example, in different rooms in the user company. In the example of FIG. 1, the recording system 20_1 includes the ink jet printer 100_1 and the processing apparatus 200_1. The recording system 20_2 includes the ink jet printer 100_2, the processing apparatus 200_2, and the mobile terminal 700.

In the example shown in FIG. 1, the number of each of the ink jet printers 100 and the processing apparatuses 200 included in the ink jet system 10 is two, but the number is not limited thereto, and may be three or more. That is, the number of sets of the recording systems 20 is not limited to two, and may be three or more.

Furthermore, the company using the ink jet system 10 is not limited to one, and may be a plurality. For example, the recording system 20_1 may be constructed in a certain company and the recording system 20_2 may be constructed in another company. In the following description, for simplification of the description, it will be assumed that only one company uses the ink jet system 10, unless otherwise specified.

FIG. 1 shows a user U_1 who uses the recording system 20_1 and a user U_2 who uses the recording system 20_2. In the following description, the users U_1 and U_2 may be collectively referred to as the user U without distinguishing each of the users U_1 and U_2. The user U is, for example, an employee of a user company. In regard to the user U, for each integer i from 1 to 2, a user U_i uses a processing apparatus 200_i in addition to an ink jet printer 100_i.

The ink jet printer 100 receives a recording job JB for executing recording processing from the processing apparatus 200. The recording job JB includes identification information (not shown) that uniquely identifies the recording job JB, and recording data DP that indicates an image formed at the recording medium PP. Moreover, the recording job JB may include information indicating the number of copies of an image formed at the recording medium PP. The recording job JB is generated by the processing apparatus 200 when the processing apparatus 200 is notified of a recording instruction PI by the operation of the user U. The recording instruction PI includes information that identifies image data that is a source of the recording data DP. The image data is data in a file format such as PostScript, PDF, or XPS. PDF is an abbreviation for Portable Document Format. XPS is an abbreviation for XML Paper Specification. The information that identifies the image data is, for example, a file path of the image data stored in the processing apparatus 200. The ink jet printer 100 forms an image based on the recording data DP at the recording medium PP.

In the example of FIG. 1, as a result of the user U_1 operating the ink jet printer 100_1, the ink jet printer 100_1 notifies the processing apparatus 200_1 of a recording instruction PI, but the present disclosure is not limited thereto. For example, when the user U_1 operates the processing apparatus 200_1, the processing apparatus 200_1 may generate a recording instruction PI, and the processing apparatus 200_1 may generate the recording job JB based on the generated recording instruction PI.

The recording medium PP is not particularly limited as long as it is a medium on which the ink jet printer 100 can print, and is, for example, various types of paper, various cloths, various films, and the like.

The ink used in the recording system 20_1 and the ink used in the recording system 20_2 may be of the same type or may be of different types. Similarly, the recording medium PP used in the recording system 20_1 and the recording medium PP used in the recording system 20_2 may be of the same type or may be of different types.

The ink jet printer 100 includes one head unit HU. In the following description, the head unit HU ejects ink from a nozzle Nz provided in the head unit HU. Hereinafter, among the elements constituting the ink jet printer 100, the elements excluding the head unit HU may be referred to as a “printer main body”.

In the example shown in FIG. 1, the ink jet printer 100 includes one head unit HU, but the number of head units HU is not limited to one and may be two or more.

The processing apparatus 200 is a desktop or laptop computer. The processing apparatus 200 executes image processing for generating the recording data DP and processing for controlling printing by the ink jet printer 100. In the image processing, the processing apparatus 200 generates recording data DP by, for example, executing various types of processing such as color conversion processing and RIP processing on the image data in a file format such as PostScript, PDF, and XPS. RIP is an abbreviation for Raster image processor. The color conversion processing is processing for converting an RGB value represented by image data in a file format into a CMYK value, a CMY value, or the like, which is an ink color used by the ink jet printer 100, with reference to a lookup table. In the following description, an example of conversion to a CMY value will be used for description. The lookup table defines the correspondence between RGB values and CMY values. The RIP processing is processing for generating recording data DP, which is data that can be printed by the ink jet printer 100, using information indicating a dither pattern and information indicating an error diffusion matrix.

The mobile terminal 700 is a portable terminal such as a smartphone or a tablet terminal. In the example of FIG. 1, the mobile terminal 700 is operated by the user U_2.

The processing apparatus 200 is communicatively connected to other devices such as the in-cloud server 300 via a network NW such as a WAN and the Internet. WAN is an abbreviation for Wide Area Network.

The in-cloud server 300 and the in-cloud server 400 are computers in a cloud system CS. The cloud system CS is a system that provides a virtual server. The cloud system CS is managed by, for example, a head manufacturer, a printer manufacturer, and a provider different from the user company. Hereinafter, the provider that manages the cloud system CS may be referred to as a “server provider”. In the present embodiment, for simplification of the description, the in-cloud server 300 and the in-cloud server 400 are managed by the same server provider, but may be managed by different server providers.

The administrator server 500 is a computer managed by a head manufacturer. However, the ink jet system 10 may not include the administrator server 500. In the present embodiment, for example, an employee belonging to the head manufacturer operates the administrator server 500 via the network NW. Hereinafter, an employee belonging to the head manufacturer may be referred to as an administrator.

The in-cloud server 300, the in-cloud server 400, and the administrator server 500 are communicatively connected to other devices via the network NW.

As described above, in the present embodiment, the in-cloud server 300 and the in-cloud server 400 are used as two in-cloud servers. To describe the reason for using two in-cloud servers, the problems when using one in-cloud server will be described.

### 1-2. Problems when Using One In-Cloud Server

A configuration may be considered in which the recording system 20 is connected to one in-cloud server in the cloud system CS to transmit condition information UI regarding usage conditions of the head unit HU to one in-cloud server. A head manufacturer provides an in-cloud server with a function of generating control information CI based on the condition information UI and transmitting the generated control information CI and accordingly, one in-cloud server can transmit control information CI suitable for the usage conditions of the head unit HU to the recording system 20. The control information CI is information for controlling a recording operation of the ink jet printer 100. The control information CI is, for example, one or both of information regarding a drive signal Com supplied to a drive element 111f, which will be described later, and information regarding image processing, which is data processing for generating recording data DP. For simplification of the description, in the present embodiment, the control information CI will be described as information regarding the drive signal Com. Since the printer manufacturer and the user company do not need to set the recording operation according to the usage conditions of the head unit HU, the man-hours load of the printer manufacturer and the user company can be significantly reduced.

However, in the aspect of using one in-cloud server, the following three problems occur. A first problem is that while the head manufacturer is updating the program of one in-cloud server, the one in-cloud server cannot provide a function of generating control information CI suitable for the condition information UI and transmitting the generated control information CI, and therefore it cannot provide the control information CI to the recording system 20, and the ink jet printer 100 cannot execute the recording operation.

Regarding the second problem, since one in-cloud server can be accessed from a plurality of recording systems 20, there is a likelihood that accesses will be concentrated on the in-cloud server. Therefore, the second problem is that while accesses are concentrated on the in-cloud server, the processing speed of the in-cloud server decreases and usability deteriorates.

Regarding a third problem, the business model of the user company may be different from the business models of the head manufacturer and the printer manufacturer. For example, the business model of the user company is to use the ink jet printer 100 under special usage conditions and produce industrial goods. In the present embodiment, the industrial goods are products purchased for the purpose of producing, processing, or reselling other products. For example, a company different from the user company purchases the industrial goods produced by the user company and produces consumer goods. Consumer goods are goods or services used by individuals and households for consumption purposes. In a business model that forms industrial goods, when the ink jet printer 100 is used under certain special usage conditions at a certain timing, and then several months or years have passed, there may be cases where the user wants to use the ink jet printer 100 again under the same usage conditions. For example, consumer goods made from industrial goods produced by the user company may become popular periodically. In this case, in order to produce industrial goods, it is preferable for the user company to use the previously set control information CI rather than setting the recording operation again because the man-hours load can be reduced. In this way, it is conceivable to store control information CI that may be used several months or years later in one in-cloud server. The third problem is that, when a case where a user wants to use the previously used control information CI is while the program of the in-cloud server is being updated or while accesses are concentrated on the in-cloud server, the recording system 20 cannot acquire the previously used control information CI, and therefore cannot execute a recording operation.

Therefore, the ink jet system 10 according to the first embodiment causes the in-cloud server 400 to generate control information CI suitable for the condition information UI and causes the in-cloud server 300 to accumulate the control information CI and provide the accumulated control information CI to the recording system 20. The configuration of each device of the ink jet system 10 will be described below.

### 1-3. Configuration of Each Device of Ink Jet System 10

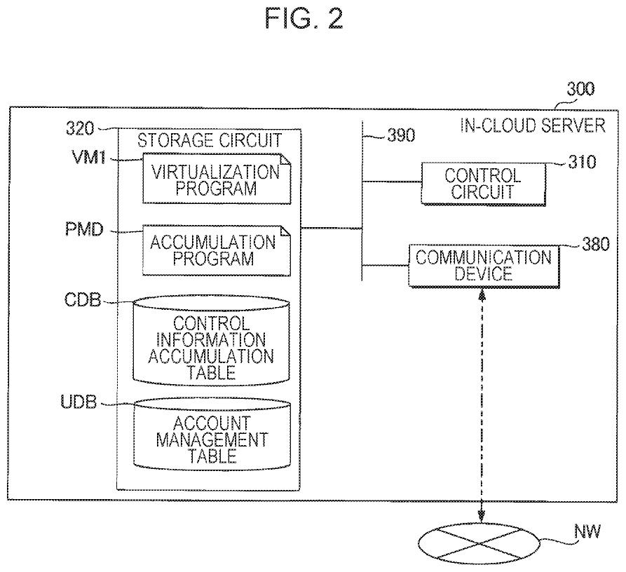

FIG. 2 is a diagram showing an example of a configuration of the in-cloud server 300. The in-cloud server 300 includes a control circuit 310, a storage circuit 320, and a communication device 380. The control circuit 310, the storage circuit 320, and the communication device 380 are coupled to one another via a bus 390 for communicating information.

The control circuit 310 includes, for example, a processor such as one or more CPUs. CPU is an abbreviation for Central Processing Unit. The control circuit 310 may include a programmable logic device such as an FPGA instead of or in addition to the CPU. FPGA is an abbreviation for Field Programmable Gate Array.

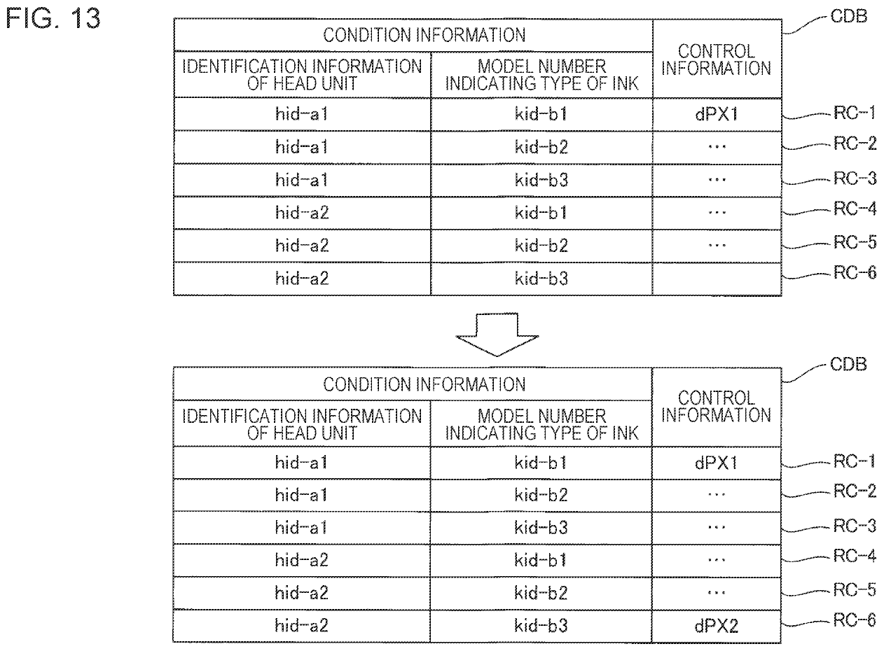

The storage circuit 320 is composed of a magnetic storage device, a flash ROM, or the like. The storage circuit 320 is readable by the control circuit 310, and stores a plurality of programs including a virtualization program VM1 and an accumulation program PMD executed by the control circuit 310, a control information accumulation table CDB, an account management table UDB, various types of information used by the control circuit 310, and the like. The virtualization program VM1 divides resources such as the control circuit 310 and the storage circuit 320 of the in-cloud server 300 into a plurality of resources, and operates each of the divided resources as a virtual server. The ink jet system 10 uses some virtual servers among the plurality of virtual servers as a portion of the in-cloud server 300. The accumulation program PMD is a program that accumulates control information CI and provides the accumulated control information CI to the recording system 20. The accumulation program PMD is developed by the head manufacturer. The control information accumulation table CDB stores the condition information UI and the control information CI in association with each other. The content of the control information accumulation table CDB will be described later with reference to FIG. 13. The account management table UDB stores information regarding a user U and information regarding an administrator for using the ink jet system 10. The information regarding the user U is, for example, an account ID and a password for using the ink jet system 10, and an e-mail address of the user U. ID is an abbreviation for identifier. Further, the information regarding the administrator is an account ID, a password, and the like of the administrator of the ink jet system 10.

The storage circuit 320 may not have the virtualization program VM1, and other devices such as the in-cloud server 400 may access the in-cloud server 300 instead of the virtual server.

The communication device 380 is hardware having a communication circuit for communicating with other devices such as the in-cloud server 400, the processing apparatus 200, and the administrator server 500 via the network NW. The communication device 380 is also referred to as a network device, a network controller, a network card, or a communication module, for example.

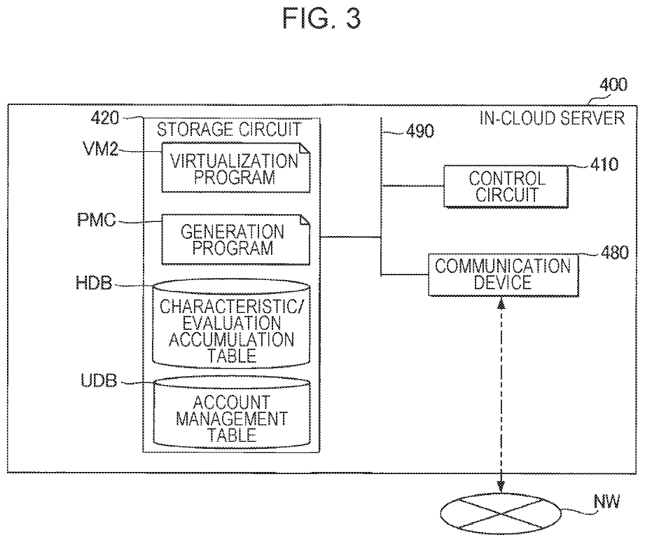

FIG. 3 is a diagram showing an example of a configuration of the in-cloud server 400. The in-cloud server 400 includes a control circuit 410, a storage circuit 420, and a communication device 480. The control circuit 410, the storage circuit 420, and the communication device 480 are coupled to one another via a bus 490 for communicating information.

The control circuit 410 includes, for example, one or more processors such as CPUs. The control circuit 410 may include a programmable logic device such as an FPGA instead of or in addition to the CPU.

The storage circuit 420 is composed of a magnetic storage device, a flash ROM, or the like. The storage circuit 420 is readable by the control circuit 410, and stores a plurality of programs including a virtualization program VM2 and a generation program PMC executed by the control circuit 410, a characteristic/evaluation accumulation table HDB, an account management table UDB, various types of information used by the control circuit 410, and the like. The virtualization program VM2 divides resources such as the control circuit 410 and the storage circuit 420 of the in-cloud server 400 into a plurality of resources, and operates each of the divided resources as a virtual server. The ink jet system 10 uses some virtual servers among the plurality of virtual servers as a portion of the in-cloud server 400. The generation program PMC is a program that generates control information CI suitable for the condition information UI. The generation program PMC is developed by the head manufacturer. The characteristic/evaluation accumulation table HDB stores characteristic information TI, which is information regarding the ejection characteristic of the head unit HU, and evaluation information HI related to the evaluation of the user U in association with each other. The characteristic information TI and the evaluation information HI will be described later. The account management table UDB is the same as the account management table UDB stored in the storage circuit 420 of the in-cloud server 300.

The storage circuit 420 may not have the virtualization program VM2, and devices other than the in-cloud server 400 may access the in-cloud server 400 instead of the virtual server.

The communication device 480 is hardware having a communication circuit for communicating with other devices such as the in-cloud server 300, the processing apparatus 200, and the administrator server 500 via the network NW. The communication device 480 is also referred to as a network device, a network controller, a network card, or a communication module, for example.

The in-cloud server 300 is an example of a “first server”. The in-cloud server 400 is an example of a “second server”.

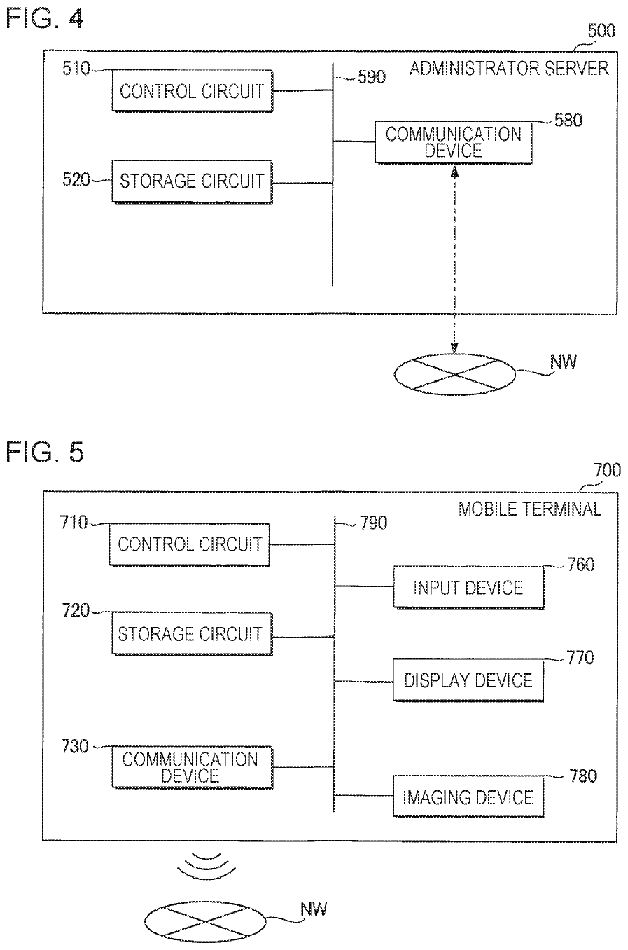

FIG. 4 is a diagram showing an example of a configuration of the administrator server 500. The administrator server 500 includes a control circuit 510, a storage circuit 520, and a communication device 580. The control circuit 510, the storage circuit 520, and the communication device 580 are coupled to one another via a bus 590 for communicating information.

The control circuit 510 includes, for example, one or more processors such as CPUs. The control circuit 510 may include a programmable logic device such as an FPGA instead of or in addition to the CPU.

The storage circuit 520 is composed of a magnetic storage device, a flash ROM, or the like. The storage circuit 520 is readable by the control circuit 510, and stores a program executed by the control circuit 510, various types of information used by the control circuit 510, and the like.

The communication device 580 is hardware having a communication circuit for communicating with other devices such as the in-cloud server 300, the in-cloud server 400, and the processing apparatus 200 via the network NW. The communication device 580 is also referred to as a network device, a network controller, a network card, or a communication module, for example.

FIG. 5 is a diagram showing a configuration of the mobile terminal 700. The mobile terminal 700 includes a control circuit 710, a storage circuit 720, a communication device 730, an input device 760, a display device 770, and an imaging device 780. The control circuit 710, the storage circuit 720, the communication device 730, the input device 760, the display device 770, and the imaging device 780 are coupled to one another via a bus 790 for communicating information.

The control circuit 710 includes, for example, one or more processors such as CPUs. The control circuit 710 may include a programmable logic device such as an FPGA instead of or in addition to the CPU.

The storage circuit 720 is composed of a magnetic storage device, a flash ROM, or the like. The storage circuit 720 is readable by the control circuit 710, and stores a program executed by the control circuit 710, various types of information used by the control circuit 710, and the like. The storage circuit 720 includes, for example, one or both semiconductor memories of one or more volatile memories such as a RAM and one or more non-volatile memories such as a ROM, an EEPROM, or a PROM.

The communication device 730 is hardware having a communication circuit for wirelessly communicating with other devices such as the in-cloud server 300 via the network NW. Specifically, the communication device 730 includes a baseband circuit, an RF circuit, and an antenna. RF is an abbreviation for Radio Frequency. The baseband circuit converts a transmission digital signal received from the control circuit 710 into a transmission analog signal, and converts a reception analog signal received from the RF circuit into a reception digital signal. The RF circuit modulates a carrier wave based on the transmission analog signal converted by the baseband circuit to generate a transmission signal, and demodulates a reception signal received via the antenna to generate a reception analog signal. The antenna transmits a transmission signal into space as a radio wave, and also receives the received radio wave as a reception signal.

The input device 760 is a device that outputs operation information according to the operation of the user U. The input device 760 is, for example, a keyboard.

The display device 770 displays an image indicating some information to the user U. The display device 770 is an organic EL display, an LED display, and an LCD. EL is an abbreviation for Electro-Luminescence. LED is an abbreviation for Light Emitting Diode. LCD is an abbreviation for Liquid Crystal Display. Alternatively, a configuration in which the input device 760 and the display device 770 are integrated may be used. The configuration in which the input device 760 and the display device 770 are integrated is, for example, a touch panel.

The imaging device 780 includes, for example, an imaging optical system and an imaging element. The imaging optical system is an optical system including at least one imaging lens, and may include various optical elements such as a prism, or may include a zoom lens, a focus lens, or the like. The imaging element is, for example, a CCD image sensor or a CMOS image sensor. CCD is an abbreviation for Charge Coupled Device. CMOS is a complementary MOS.

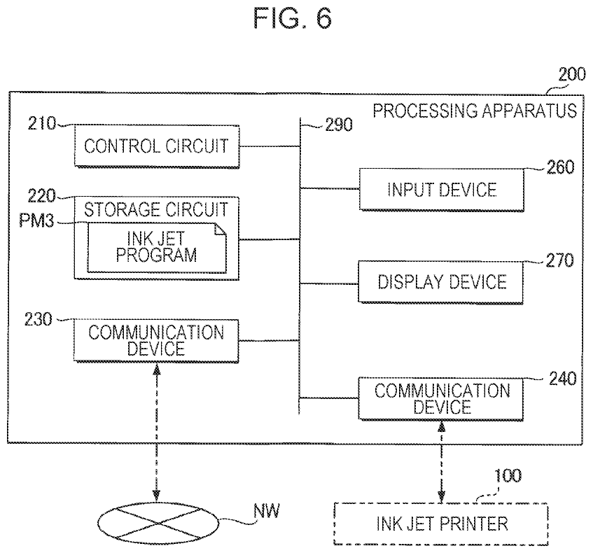

FIG. 6 is a diagram showing a configuration of the processing apparatus 200. The processing apparatus 200 includes a control circuit 210, a storage circuit 220, a communication device 230, a communication device 240, an input device 260, and a display device 270. The control circuit 210, the storage circuit 220, the communication device 230, the communication device 240, the input device 260, and the display device 270 are coupled to one another via a bus 290 for communicating information.

The control circuit 210 includes, for example, a processor such as one or more CPUs. The control circuit 210 may include a programmable logic device such as an FPGA instead of or in addition to the CPU.

The storage circuit 220 is composed of a magnetic storage device, a flash ROM, or the like. The storage circuit 220 is readable by the control circuit 210, and stores a plurality of programs including an ink jet program PM3 executed by the control circuit 210, various types of information used by the control circuit 210, and the like. The storage circuit 220 includes, for example, one or both semiconductor memories of one or more volatile memories such as a RAM and one or more non-volatile memories such as a ROM, an EEPROM, or a PROM. When the processing apparatus 200 is coupled to the ink jet printer 100, the ink jet program PM3 is downloaded from the virtual server operating on the in-cloud server 300 and installed in the processing apparatus 200, for example.

The communication device 230 is hardware having a communication circuit for communicating with other devices such as the in-cloud server 300 via the network NW. The communication device 230 is also referred to as a network device, a network controller, a network card, or a communication module, for example.

The communication device 240 is a circuit capable of communicating with the ink jet printer 100. For example, the communication device 240 is a network card such as USB or Bluetooth. USB is an abbreviation for Universal Serial Bus. USB and Bluetooth are registered trademarks.

The input device 260 is a device that outputs operation information according to the operation of the user U. The input device 260 is, for example, a mouse and a keyboard.

The display device 270 displays an image indicating some information to the user U. The display device 270 is an organic EL display, an LED display, and an LCD. Alternatively, a configuration in which the input device 260 and the display device 270 are integrated may be used.

As described above, there has been a business model in which the head manufacturer provides the head unit HU to the printer manufacturer, and the printer manufacturer manufactures the ink jet printer 100 by incorporating the head unit HU into the printer main body. In this business model, printer manufacturers generally design and manufacture components other than the head unit HU. In the present embodiment, the head manufacturer prepares the in-cloud server 300 and the ink jet program PM3 that operates on the processing apparatus 200, and the user U connects the processing apparatus 200 to the in-cloud server 300 and causes the processing apparatus 200 to operate the ink jet program PM3. As described above, in the present embodiment, since the printer manufacturer does not need to prepare the ink jet program PM3, the load of the printer manufacturer for designing and manufacturing components can be reduced.

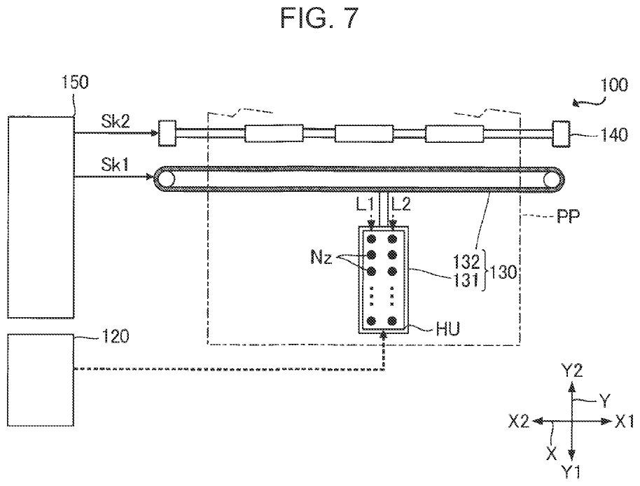

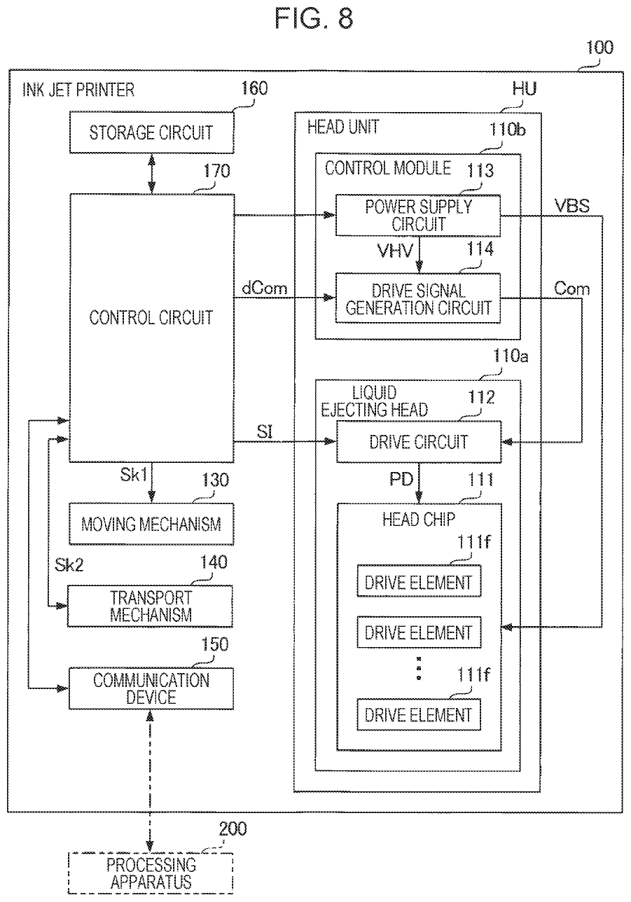

FIG. 7 is a schematic diagram illustrating an example of a configuration of the ink jet printer 100. FIG. 8 is a block diagram showing a configuration example of the ink jet printer 100. In the following description, an X-axis, a Y-axis, and a Z-axis which are orthogonal to each other are assumed. One direction along the X-axis when viewed from an optional point is referred to as an X1 direction, and a direction opposite to the X1 direction is referred to as an X2 direction. Similarly, directions opposite to each other along the Y-axis from an optional point are referred to as a Y1 direction and a Y2 direction, and directions opposite to each other along the Z-axis from an optional point are referred to as a Z1 direction and a Z2 direction. An X-Y plane including the X-axis and the Y-axis corresponds to a horizontal plane. The Z-axis is an axis along a vertical direction, and the Z2 direction corresponds to a downward direction in the vertical direction.

The ink jet printer 100 according to the first embodiment is a serial printer that forms an image on the recording medium PP using a multi-pass method. The multi-pass method refers to forming an image on the recording medium PP by scanning a plurality of times. Specifically, as shown in FIG. 7, the ink jet printer 100 according to the first embodiment executes a recording operation of forming an image at the recording medium PP by ejecting ink from the nozzle Nz while transporting the recording medium PP in the Y1 direction, which is a sub-scanning direction, and moving the head unit HU in the X1 direction and the X2 direction, which are main scanning directions. In FIG. 7, some nozzles Nz among the plurality of nozzles Nz included in the head unit HU are representatively shown.

As shown in FIGS. 7 and 8, the ink jet printer 100 includes a head unit HU, a liquid container 120, a moving mechanism 130, a transport mechanism 140, a communication device 150, a storage circuit 160, and a control circuit 170.

The head unit HU is an assembly having a head chip 111, a drive circuit 112, a power supply circuit 113, and a drive signal generation circuit 114.

In the example shown in FIG. 7, the head unit HU is divided into a liquid ejecting head 110a including the head chip 111 and the drive circuit 112, and a control module 110b including the power supply circuit 113 and the drive signal generation circuit 114. The head unit HU is not limited to the aspect divided into the liquid ejecting head 110a and the control module 110b, and for example, a portion or all of the control module 110b may be incorporated into the liquid ejecting head 110a.

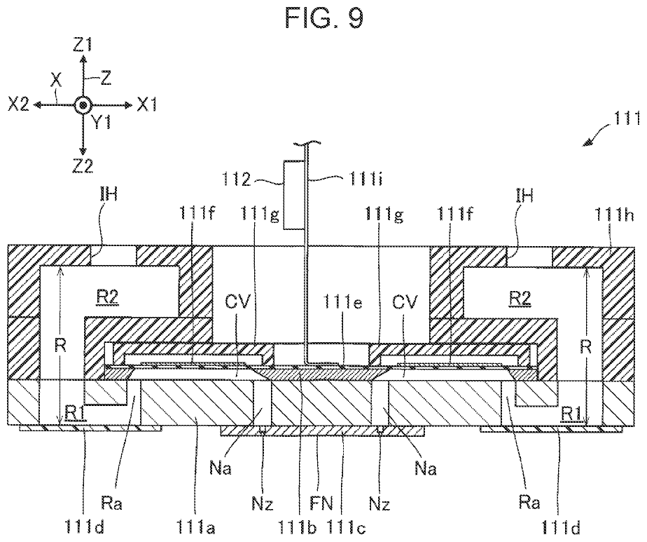

The head chip 111 ejects ink toward the recording medium PP. In FIG. 7, among the components of the head chip 111, a plurality of drive elements 111f are representatively shown. A detailed example of the head chip 111 will be described later with reference to FIG. 9.

In the example shown in FIG. 8, the number of head chips 111 included in the head unit HU is one, but the number thereof may be two or more. One or more head chips 111 are arranged such that the plurality of nozzles Nz are distributed over a portion of the width direction of the recording medium PP.

Under the control of the control circuit 170, the drive circuit 112 switches whether or not to supply a drive signal Com output from the drive signal generation circuit 114 to each of the plurality of drive elements 111f of the head chip 111. The drive circuit 112 includes, for example, a group of switches such as a transmission gate for the switching.

The power supply circuit 113 receives power supplied from a commercial power supply (not shown) and generates various predetermined potentials. The generated various potentials are appropriately supplied to each section of the ink jet printer 100. In the example shown in FIG. 8, the power supply circuit 113 generates a power supply potential VHV and an offset potential VBS. The offset potential VBS is supplied to the head chip 111 and the like. Also, the power supply potential VHV is supplied to the drive signal generation circuit 114 and the like.

The drive signal generation circuit 114 is a circuit that generates a drive signal Com for driving each drive element 111f of the head chip 111. Specifically, the drive signal generation circuit 114 includes, for example, a DA conversion circuit and an amplifier circuit. In the drive signal generation circuit 114, the DA conversion circuit converts a waveform designation signal dCom to be described later from the control circuit 170 from a digital signal to an analog signal, and the amplifier circuit generates a drive signal Com by amplifying the analog signal using the power supply potential VHV from the power supply circuit 113. Here, among the waveforms included in the drive signal Com, the signal of the waveform actually supplied to the drive element 111f is a drive pulse PD.

As illustrated in FIG. 7, the liquid container 120 that stores ink is installed in the ink jet printer 100. For example, a cartridge that is detachably attached to the ink jet printer 100, a bag-shaped ink pack formed of a flexible film, or an ink tank that can be replenished with ink is used as the liquid container 120.

The moving mechanism 130 and the transport mechanism 140 move the relative positions of the recording medium PP and the head unit HU under the control of the control circuit 170. The movement of the relative position may mean moving the head unit HU while the position of the recording medium PP is fixed, or moving the recording medium PP while the position of the head unit HU is fixed. In the present embodiment, in the direction along the X-axis, which is the main scanning direction, the head unit HU is moved in the direction along the X-axis while the position of the recording medium PP on the X-axis is fixed, and in the Y1 direction, which is the sub-scanning direction, the recording medium PP is moved in the Y1 direction while the position of the head unit HU in the direction along the Y-axis is fixed.

The moving mechanism 130 reciprocates the head unit HU along the X-axis under the control of the control circuit 170. As shown in FIG. 7, the moving mechanism 130 includes a substantially box-shaped carriage 131 accommodating the head unit HU and an endless belt 132 to which the head unit HU is fixed. A configuration in which the liquid container 120 is mounted on the carriage 131 together with the head unit HU may also be employed.

The transport mechanism 140 transports the recording medium PP in the Y1 direction under the control of the control circuit 170. Specifically, the transport mechanism 140 includes a transport roller (not shown) whose rotation axis is parallel to the X-axis, and a motor (not shown) that rotates the transport roller under control by the control circuit 170.

The communication device 150 is a circuit capable of communicating with the processing apparatus 200. For example, the communication device 150 is a network card such as USB or Bluetooth. Also, the communication device 150 may be integrated with the control circuit 170.

The storage circuit 160 stores various programs executed by the control circuit 170 and various types of data such as the recording job JB processed by the control circuit 170. The storage circuit 160 includes, for example, one or both semiconductor memories of one or more volatile memories such as a RAM and one or more non-volatile memories such as a ROM, an EEPROM, or a PROM. The storage circuit 160 may be configured as a portion of the control circuit 170.

The control circuit 170 has a function of controlling the operation of each section of the ink jet printer 100 and a function of processing various types of data. The control circuit 170 includes, for example, a processor such as one or more CPUs. The control circuit 170 may include a programmable logic device such as an FPGA instead of or in addition to the CPU.

The control circuit 170 controls the operation of each section of the ink jet printer 100 by executing a program stored in the storage circuit 160. Here, the control circuit 170 generates signals such as a control signal Sk1, a control signal Sk2, a print signal SI, and a waveform designation signal dCom as signals for controlling the operations of each section of the ink jet printer 100.

The control signal Sk1 is a signal for controlling driving of the moving mechanism 130. The control signal Sk2 is a signal for controlling driving of the transport mechanism 140. The print signal SI is a signal for controlling driving the drive circuit 112. Specifically, the print signal SI designates whether or not the drive circuit 112 supplies the drive signal Com from the drive signal generation circuit 114 to the drive element 111f for each predetermined unit period. By this designation, the amount of ink ejected from the head chip 111 and the like are designated. The waveform designation signal dCom is a digital signal for defining the waveform of the drive signal Com generated by the drive signal generation circuit 114.

When the recording operation is executed, the control circuit 170 first causes the storage circuit 160 to store the recording job JB supplied from the processing apparatus 200. Next, the control circuit 170 generates various control signals such as the print signal SI, the waveform designation signal dCom, the control signal Sk1, and the control signal Sk2 based on various types of data such as the recording data DP included in the recording job JB stored in the storage circuit 160. Thereafter, the control circuit 170 controls the head unit HU such that the drive element 111f is driven while controlling the transport mechanism 140 and the moving mechanism 130 so as to change a relative position of the recording medium PP with respect to the head unit HU based on the various control signals and various types of data stored in the storage circuit 160. Accordingly, the control circuit 170 adjusts the presence/absence of ink ejection from the drive element 111f, the ejection amount of ink, the ejecting timing of the ink, and the like, and controls the execution of the recording operation of forming an image based on the recording data DP at the recording medium PP.

FIG. 9 is a cross-sectional view showing a configuration example of the head chip 111. In the following description, the X-axis, Y-axis, and Z-axis that intersect each other are appropriately used. In the following, one direction along the X-axis is an X1 direction, and a direction opposite to the X1 direction is an X2 direction. Similarly, mutually opposite directions along the Y-axis are a Y1 direction and a Y2 direction. Mutually opposite directions along the Z-axis are a Z1 direction and a Z2 direction.

As shown in FIGS. 7 and 9, the head chip 111 has the plurality of nozzles Nz arranged in the direction along the Y-axis. As shown in FIG. 7, the plurality of nozzles Nz are divided into a first row L1 and a second row L2 which are arranged at intervals in a direction along the X-axis. Each of the first row L1 and the second row L2 is a set of a plurality of nozzles Nz linearly arranged in the direction along the Y-axis.

The head chip 111 has a configuration substantially symmetrical with each other in the direction along the X-axis. However, positions of the plurality of nozzles Nz in the first row L1 and the plurality of nozzles Nz in the second row L2 in the direction along the Y-axis may match or differ from each other. FIG. 9 shows a configuration in which the positions of the plurality of nozzles Nz in the first row L1 and the plurality of nozzles Nz in the second row L2 match each other in the direction along the Y-axis.

As shown in FIG. 9, the head chip 111 includes a flow path substrate 111a, a pressure chamber substrate 111b, a nozzle plate 111c, vibration absorbers 111d, a vibration plate 111e, a plurality of drive elements 111f, protective plates 111g, a case 111h, and a wiring substrate 111i.

The flow path substrate 111a and the pressure chamber substrate 111b are stacked in this order in the Z1 direction, and form a flow path for supplying ink to a plurality of nozzles Nz. The vibration plate 111e, the plurality of drive elements 111f, the protective plates 111g, the case 111h, and the wiring substrate 111i are installed in a region located in the Z1 direction with respect to a stacked body formed by the flow path substrate 111a and the pressure chamber substrate 111b. On the other hand, the nozzle plate 111c and the vibration absorbers 111d are installed in a region located in the Z2 direction with respect to the stacked body. Each element of the head chip 111 is schematically a plate-shaped member elongated in the Y direction, and is bonded to each other with, for example, an adhesive. Hereinafter, each element of the head chip 111 will be described in order.

The nozzle plate 111c is a plate-shaped member provided with a plurality of nozzles Nz in each of the first row L1 and the second row L2. Each of the plurality of nozzles Nz is a through hole through which ink passes. Here, the surface of the nozzle plate 111c facing the Z2 direction is a nozzle surface FN. The nozzle plate 111c is manufactured by processing a silicon single crystal substrate by a semiconductor manufacturing technique using a processing technique such as dry etching or wet etching, for example. Here, other known methods and materials may be appropriately used for manufacturing the nozzle plate 111c. In addition, although the cross-sectional shape of the nozzle Nz is typically circular, the shape is not limited thereto and may be, for example, a non-circular shape such as polygonal and elliptical shapes.

The flow path substrate 111a is provided with a space R1, a plurality of supply flow paths Ra, and a plurality of communication flow paths Na for each of the first row L1 and the second row L2. The space R1 is an elongated opening extending in the direction along the Y-axis in a plan view in the direction along the Z-axis. Each of the supply flow path Ra and the communication flow path Na is a through hole formed for each nozzle Nz. Each supply flow path Ra communicates with the space R1.

The pressure chamber substrate lib is a plate-shaped member provided with a plurality of pressure chambers CV referred to as cavities for each of the first row L1 and the second row L2. The plurality of pressure chambers CV are arranged in the direction along the Y-axis. Each pressure chamber CV is an elongated space formed for each nozzle Nz and extending in the direction along the X-axis in a plan view. Each of the flow path substrate 111a and the pressure chamber substrate 111b is manufactured by processing a silicon single crystal substrate by a semiconductor manufacturing technique, for example, in the same manner as the nozzle plate 111c described above. Here, other known methods and materials may be appropriately used for the manufacturing of each of the flow path substrate 111a and the pressure chamber substrate 111b.

The pressure chamber CV is a space located between the flow path substrate 111a and the vibration plate 111e. For each of the first row L1 and the second row L2, the plurality of the pressure chambers CV are arranged in the direction along the Y-axis. Further, the pressure chamber CV communicates with each of the communication flow path Na and the supply flow path Ra. Therefore, the pressure chamber CV communicates with the nozzle Nz through the communication flow path Na and communicates with the space R1 through the supply flow path Ra.

The vibration plate 111e is arranged on the surface of the pressure chamber substrate 111b facing the Z1 direction. The vibration plate 111e is a plate-shaped member that can elastically vibrate. The vibration plate 111e has, for example, a first layer and a second layer, which are stacked in the Z1 direction in this order. The first layer is an elastic film made of silicon oxide (SiO₂), for example. The elastic film is formed, for example, by thermally oxidizing one surface of a silicon single crystal substrate. The second layer is an insulating film made of zirconium oxide (ZrO₂), for example. The insulating film is formed by, for example, forming a zirconium layer by sputtering and thermally oxidizing the layer. The vibration plate 11e is not limited to the above-mentioned stacked configuration of the first layer and the second layer, and may be composed of, for example, a single layer or three or more layers.

On the surface of the vibration plate 11e facing the Z1 direction, the plurality of drive elements 111f corresponding to the nozzles Nz are arranged for each of the first row L1 and the second row L2. Each drive element 111f is a passive element deformed by the drive signal Com being supplied. Each drive element 111f has an elongated shape extending in the direction along the X-axis in a plan view. The plurality of drive elements 111f are arranged in the direction along the Y-axis so as to correspond to the plurality of pressure chambers CV. The drive element 111f overlaps the pressure chamber CV in a plan view.

Each drive element 111f is a piezoelectric element, and although not shown, it has a first electrode, a piezoelectric layer, and a second electrode, which are stacked in the Z1 direction in this order. One electrode of the first electrode and the second electrode is an individual electrode arranged apart from the other for each drive element 111f, and the drive pulse PD is supplied to the one electrode. The other electrode of the first electrode and the second electrode is a strip-shaped common electrode extending in the direction along the Y-axis to be continuous over the plurality of drive elements 111f, and the offset potential VBS is supplied to the other electrode. Examples of metal materials of the electrodes include metal materials such as platinum (Pt), aluminum (Al), nickel (Ni), gold (Au), and copper (Cu), and among these, one type can be used alone, or two or more types can be used in combination in an alloy or stacked aspect. The piezoelectric layer is made of a piezoelectric material such as lead zirconate titanate (Pb(Zr, Ti)O₃), and has, for example, a strip shape extending in the direction along the Y-axis to be continuous over the plurality of drive elements 111f. Here, the piezoelectric layer may be integrated over the plurality of drive elements 111f. In this case, the piezoelectric layer is provided with through holes extending in the direction along the X-axis, penetrating through the piezoelectric layer in regions corresponding to the gaps between the pressure chambers CV adjacent to each other in a plan view. When the vibration plate 11e vibrates in conjunction with the above deformation of the drive elements 111f, the pressures in the pressure chambers CV fluctuate, and ink is ejected from the nozzles Nz.

The protective plate 11g is a plate-shaped member installed on the surface of the vibration plate 11e facing the Z1 direction, and protects the plurality of drive elements 111f and reinforces the mechanical strength of the vibration plate 11e. Here, the plurality of drive elements 111f are accommodated between the protective plate 11g and the vibration plate 11e. The protective plate 11g is made of, for example, a resin material.

The case 111h is a member for storing ink supplied to the plurality of pressure chambers CV. The case 111h is made of, for example, a resin material. The case 111h is provided with a space R2 for each of the first row L1 and the second row L2. The space R2 is a space that communicates with the above-mentioned space R1 and functions as a reservoir R for storing ink supplied to the plurality of pressure chambers CV together with the space R1. An introduction port IH for supplying ink to each reservoir R is provided in the case 111h. The ink in each reservoir R is supplied to the pressure chamber CV through each supply flow path Ra.

The vibration absorber 111d, also referred to as a compliance substrate, is a flexible resin film constituting a wall surface of the reservoir R, and absorbs pressure fluctuations of ink in the reservoir R. The vibration absorber 111d may be a flexible thin plate made of metal. The surface of the vibration absorber 111d facing the Z1 direction is bonded to the flow path substrate 111a with an adhesive or the like.

The wiring substrate 111i is mounted on the surface of the vibration plate 111e facing the Z1 direction, and is a mounting component for electrically coupling the head chip 111, the drive circuit 112, the control module 110b, and the like. The wiring substrate 111i is, for example, a flexible wiring substrate such as COF, FPC, or FFC. The above-mentioned drive circuit 112 is mounted on the wiring substrate 111i of the present embodiment. COF is an abbreviation for Chip On Film. FPC is an abbreviation for Flexible Printed Circuit. FFC is an abbreviation for Flexible Flat Cable.

### 1-4. Functions and Operations of Ink Jet System 10

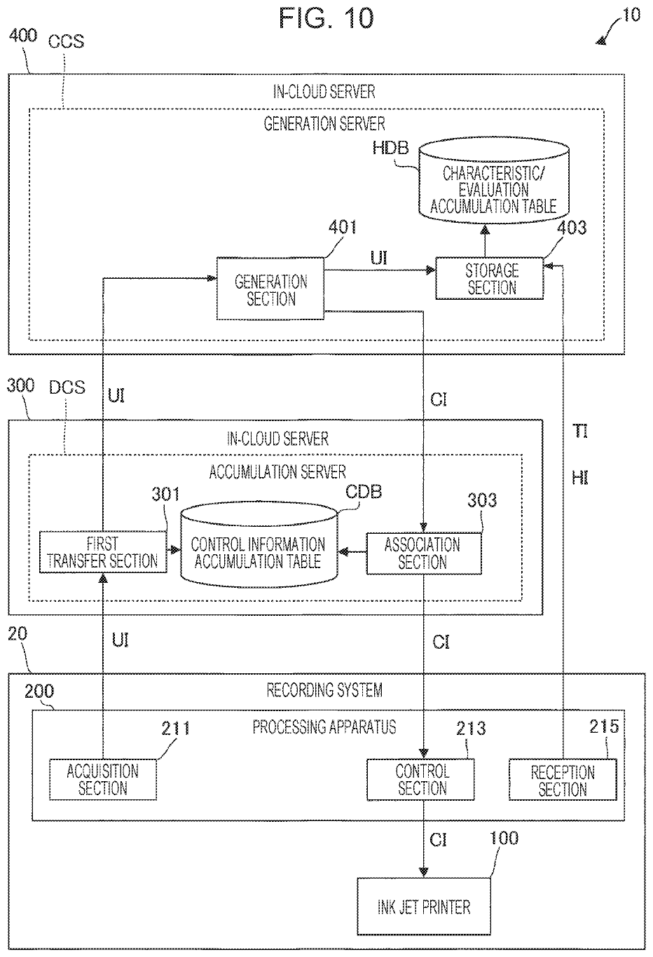

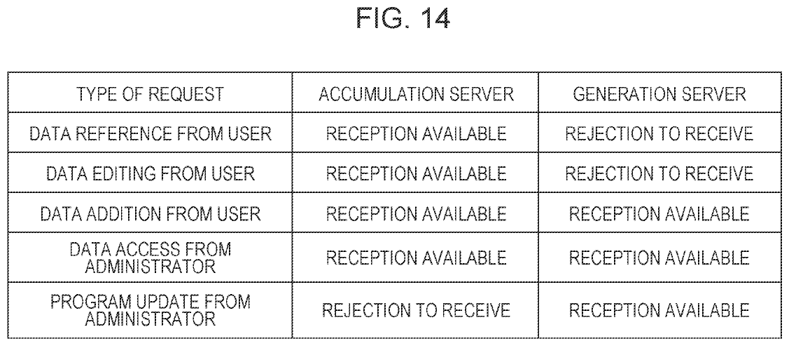

Functions and operations of the ink jet system 10 will be described with reference to FIGS. 10 to 14. In FIGS. 10 to 13, functions and operations when the recording operation is executed will be described. In FIG. 14, processing when there is a request to access data in the ink jet system 10 and an update request for a program in the ink jet system 10 will be described.

FIG. 10 is a diagram showing functions of the ink jet system 10. FIG. 10 shows the functions of the ink jet system 10 when a recording operation according to new condition information UI is executed. The control circuit 210 in the processing apparatus 200 reads the ink jet program PM3 and executes the read ink jet program PM3 to function as an acquisition section 211, a control section 213, and a reception section 215. The in-cloud server 300 functions as a plurality of virtual servers by reading the virtualization program VM1 and executing the read virtualization program VM1. Among the plurality of virtual servers, one virtual server used by the ink jet system 10 may be referred to as an accumulation server DCS. The accumulation server DCS reads the accumulation program PMD and executes the accumulation program PMD, and therefore the accumulation server DCS functions as a first transfer section 301 and an association section 303. Furthermore, the control information accumulation table CDB is updated by executing the accumulation program PMD.

The in-cloud server 400 functions as a plurality of virtual servers by reading the virtualization program VM2 and executing the read virtualization program VM2. Among the plurality of virtual servers, one virtual server used by the ink jet system 10 may be referred to as a generation server CCS. The generation server CCS reads the generation program PMC and executes the generation program PMC, thereby functioning as a generation section 401 and a storage section 403. Furthermore, the characteristic/evaluation accumulation table HDB is updated by executing the generation program PMC.

The ink jet printer 100 may include an input device and a display device, and may function as the acquisition section 211, the control section 213, and the reception section 215. In addition, in the first embodiment, the processing apparatus 200 is connected to the network NW, but the ink jet printer 100 may be connected to the network NW.

Also, when the in-cloud server 300 does not function as a virtual server, the control circuit 310 of the in-cloud server 300 executes the accumulation program PMD, and therefore the control circuit 310 may function as the first transfer section 301 and the association section 303.

Also, when the in-cloud server 400 does not function as a virtual server, the control circuit 410 of the in-cloud server 400 executes the generation program PMC, and therefore the control circuit 410 may function as the generation section 401 and the storage section 403.

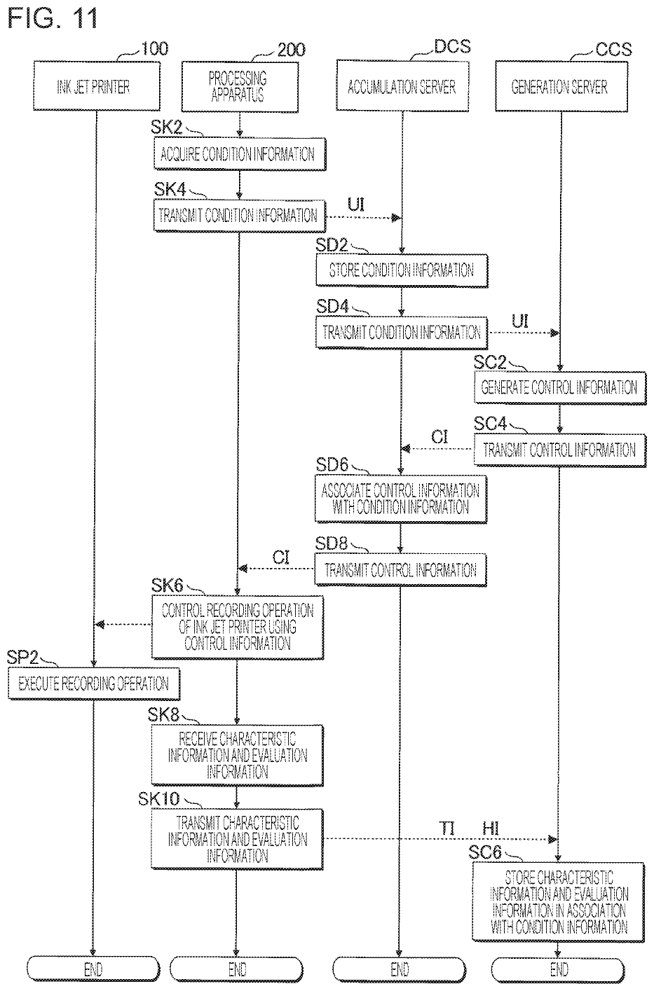

FIG. 11 is a flowchart showing a series of operations of the ink jet system 10 when a recording operation according to the new condition information UI is executed. The series of operations shown in FIG. 11 is executed when the user U instructs the processing apparatus 200 to receive the provision of the control information CI because the ink jet printer 100 executes the recording operation. Before step SK2 shown in FIG. 11, the processing apparatus 200 accesses the accumulation server DCS and logs in to the ink jet system 10 using an account ID and a password of the user U, through the operation of the user U. After logging in, in step SK2, the control circuit 210 that functions as the acquisition section 211 acquires the condition information UI.

The condition information UI includes one or more pieces of information regarding the type of the head unit HU, information regarding the type of ink, information regarding the type of the recording medium PP, and information regarding the temperature in the usage environment of the head unit HU. The information regarding the type of the head unit HU is, for example, a character string indicating a model number of the head unit HU or an identification number of the head unit HU. The information regarding the type of ink is, for example, information indicating the characteristics of the ink, or a name or model number indicating the type of the ink. The information indicating the characteristics of the ink is, for example, viscosity. The information regarding the type of the recording medium PP is information indicating the characteristics of the recording medium PP or a name indicating the type of the recording medium PP. The characteristic of the recording medium PP is, for example, ease of bleeding. The temperature in the usage environment of the head unit HU is a so-called environmental temperature. The environmental temperature can be said to be a temperature of a space in which the ink jet printer 100 equipped with the head unit HU is installed, or can be said to be a temperature around the ink jet printer 100. The information regarding the environmental temperature is, for example, information indicating the degree Celsius of the environmental temperature. In addition, the condition information UI may include information other than each piece of information described above instead of or in addition to each piece of information described above. For example, the condition information UI may include one or more pieces of information regarding humidity in the usage environment of the head unit HU, information regarding the static surface tension or the dynamic surface tension of the ink, and information regarding classification of the recording medium PP, such as plain paper, coated paper, and vinyl chloride sheet.

For example, the acquisition section 211 acquires the condition information UI by causing the user U to input each piece of information included in the condition information UI using the input device 260. Alternatively, when each piece of information included in the condition information UI can be acquired from the ink jet printer 100, the acquisition section 211 may acquire the information from the ink jet printer 100. For example, when the ink jet printer 100 includes a temperature sensor, the acquisition section 211 acquires a value indicating a temperature measured by the temperature sensor from the ink jet printer 100. Furthermore, the mobile terminal 700 may function as the acquisition section 211. For example, a barcode or a two-dimensional code indicating the identification number of the head unit HU may be printed on the side surface of the housing of the head unit HU or the like. The mobile terminal 700 images the barcode or the two-dimensional code using the imaging device 780 according to the operation of the user U. The control circuit 710 in the mobile terminal 700 acquires image information indicating an image captured by the imaging device 780. When the image information is acquired, the control circuit 710 analyzes the image information to acquire the identification number of the head unit HU.

After the processing in step SK2 ends, under the control of the control circuit 210, the communication device 230 transmits the condition information UI to the accumulation server DCS in step SK4. The processing apparatus 200 waits until a response is received from the accumulation server DCS. When the mobile terminal 700 functions as the acquisition section 211, the communication device 730 transmits, to the accumulation server DCS, the identification number of the head unit HU, which is the condition information UI, and an instruction to transmit the control information CI corresponding to the condition information UI to the processing apparatus 200. The instruction to transmit the control information CI corresponding to the condition information UI to the processing apparatus 200 includes, for example, the IP address of the processing apparatus 200. IP is an abbreviation for Internet Protocol.

When the condition information UI is received, the accumulation server DCS stores the condition information UI in the control information accumulation table CDB in step SD2. Details of the processing in step SD2 will be described later when step SD6 is described. After the processing in step SD2 ends, the accumulation server DCS functions as the first transfer section 301, and transmits the condition information UI to the generation server CCS in step SD4. The accumulation server DCS waits for a response from the generation server CCS.

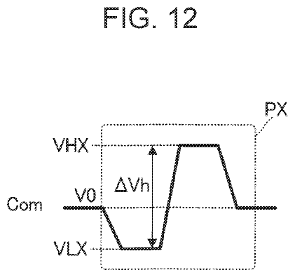

When the condition information UI is received, the generation server CCS functions as the generation section 401 and generates the control information CI based on the condition information UI in step SC2. An example of the control information CI according to the first embodiment will be described with reference to FIG. 12.

FIG. 12 is a diagram for describing an example of the control information CI according to the first embodiment. FIG. 12 shows an example of a waveform PX of the drive signal Com. The waveform PX has a period in which an intermediate potential VO is maintained, a period in which the potential is lowered from the intermediate potential VO to a lowest potential VLX, a period in which the lowest potential VLX is maintained, a period in which the potential is increased from the lowest potential VLX to a highest potential VHX, a period in which the highest potential VHX is maintained, and a period in which the potential is lowered from the highest potential VHX to the intermediate potential VO. As a potential difference ΔVh between the lowest potential VLX and the highest potential VHX is increased, the ejection amount can be increased.

In the first embodiment, the control information CI is a parameter related to the waveform PX of the drive signal Com, which is an example of information regarding the drive signal Com. The parameter related to the waveform PX may be, for example, information indicating the shape of the waveform PX, or information indicating one or both of the lowest potential VLX and the highest potential VHX. In the following description, the control information CI will be described as information indicating the shape of the waveform PX.

The head unit HU may have some manufacturing errors. Even when a certain predetermined drive signal Com is applied to the head unit HU, the shape of the pressure chamber CV deviates from the shape assumed by the head manufacturer due to the manufacturing error, and as a result, the ejection amount of ink ejected from the head unit HU may differ from a predetermined ejection amount defined by the head manufacturer. For example, it is assumed that the information included in the condition information UI is the identification number of the head unit HU. The generation server CCS stores a table indicating an ejection amount of the head unit HU for each identification number of the head unit HU. The generation section 401 refers to the above-mentioned table from the identification number of the head unit HU included in the condition information UI and determines, as the control information CI, information indicating the shape of the waveform PX having a potential difference ΔVh that cancels manufacturing errors.

In addition, the ejection amount may fluctuate depending on the type of ink. For example, as the viscosity of the ink increases, the ejection amount tends to decrease. It is assumed that the information included in the condition information UI is information indicating the viscosity of the ink, and the viscosity is higher than a general viscosity. Based on this assumption, the generation section 401 determines, as the control information CI, information indicating the shape of the waveform PX having a potential difference ΔVh larger than the potential difference ΔVh of the waveform PX in the initial state.

Also, the state after the ink lands on the recording medium PP may fluctuate depending on the type of the recording medium PP. For example, as the thickness of the recording medium PP becomes thinner, ink tends to bleed more easily. It is assumed that the information included in the condition information UI is information indicating the characteristics of the recording medium PP, and has the characteristic that the ink easily bleeds. Based on this assumption, the generation section 401 determines, as the control information CI, information indicating the shape of the waveform PX having a potential difference ΔVh smaller than the potential difference ΔVh of the waveform PX in the initial state.

Also, the ejection amount may fluctuate depending on the environmental temperature. For example, as the environmental temperature decreases, the viscosity of the ink increases, and as a result of the increased viscosity of the ink, the ejection amount tends to decrease. It is assumed that the information included in the condition information UI is the information regarding the environmental temperature and indicates a temperature lower than normal temperature. Based on this assumption, the generation section 401 determines, as the control information CI, information indicating the shape of the waveform PX having a potential difference ΔVh larger than the potential difference ΔVh of the waveform PX in the initial state.

The description will now return to FIG. 11. After the processing in step SC2 ends, the generation server CCS transmits the determined control information CI to the accumulation server DCS in step SC4.

When the control information CI is received, the accumulation server DCS functions as the association section 303 in step SD6, and stores the control information CI in the control information accumulation table CDB in association with the condition information UI received by the processing in step SD2. The processing in step SD2 and step SD6 will be described with reference to FIG. 13.

FIG. 13 is a diagram for describing processing in step SD2 and step SD6. In FIG. 13, it is assumed that the condition information UI is the identification number of the head unit HU and the model number indicating the type of ink. The upper portion of FIG. 13 shows an example of the control information accumulation table CDB immediately after the processing in step SD2. As shown in FIG. 13, the control information accumulation table CDB stores the control information CI for each piece of condition information UI. In the control information accumulation table CDB shown in the upper portion of FIG. 13, six records from a record RC-1 to a record RC-6 are registered. For example, the record RC-1 indicates that when the identification information of the head unit HU is “hid-a1” and the model number indicating the type of ink is “kid-b1”, the control information CI is information dPX1 indicating the shape of the waveform PX.

In step SD2, the accumulation server DCS adds the record having the condition information UI received from the processing apparatus 200 to the control information accumulation table CDB. In the example at the upper portion of FIG. 13, the accumulation server DCS adds the record RC-6 to the control information accumulation table CDB. FIG. 11 shows a series of operations of the ink jet system 10 when the recording operation according to the new condition information UI is executed, but when the recording operation according to the existing condition information UI is executed, the same information as the condition information UI received from the processing apparatus 200 has already been registered in the control information accumulation table CDB. Therefore, the accumulation server DCS transmits, to the processing apparatus 200, control information CI associated with the same information as the condition information UI received from the processing apparatus 200.

In step SD6, the accumulation server DCS registers the control information CI received from the generation server CCS in a field of the control information CI of the record added to the control information accumulation table CDB by the processing in step SD2. In the example at the lower portion of FIG. 13, the accumulation server DCS registers information dPX2, which is an example of the control information CI received from the generation server CCS, in the field of the control information CI of the record RC-6. In step SD6, in order to easily specify which record is added by the processing in step SD2 among the plurality of records in the control information accumulation table CDB, for example, the control information accumulation table CDB may add different sequence numbers to each record. In step SD4, the accumulation server DCS transmits the condition information UI and the sequence number to the generation server CCS. In step SC4, the generation server CCS transmits the condition information UI and the sequence number to the accumulation server DCS. In step SD6, the accumulation server DCS can specify the record added by the processing in step SD2 by referring to the sequence number received from the generation server CCS.

The description will now return to FIG. 11. After the processing in step SD6 ends, the accumulation server DCS transmits the control information CI to the processing apparatus 200 in step SD8. When the mobile terminal 700 functions as the acquisition section 211, the accumulation server DCS transmits the control information CI to the processing apparatus 200 in accordance with an instruction to transmit the control information CI corresponding to the condition information UI to the processing apparatus 200.

When the control information CI is received, the control circuit 210 functions as the control section 213 and controls the recording operation of the ink jet printer 100 using the control information CI in step SK6. Specifically, the control circuit 210 transmits the control information CI to the ink jet printer 100. In step SP2, the ink jet printer 100 applies the waveform PX indicated by the control information CI to the drive element 111f.

After the recording operation ends, the control circuit 210 functions as the reception section 215, and receives the characteristic information TI and the evaluation information HI in step SK8. The characteristic information TI is, for example, one or more pieces of information indicating an ejection amount of ink from the nozzle Nz included in the head unit HU, information indicating an ejection speed of the ink ejected from the nozzle Nz, and information indicating ejection stability of the ink from the nozzle Nz. The ejection stability means a property that the ink ejected from the nozzles Nz lands at a landing position assumed by the head manufacturer. Specifically, this means that the closer the actual landing position of the ink ejected from the nozzle Nz to the landing position assumed by the head manufacturer, the higher the ejection stability.

In order to receive one or both of the information indicating the ejection amount and the information indicating the ejection speed, for example, the ink jet printer 100 includes an imaging device provided at a position in the Z2 direction from the nozzle Nz to capture an image of the ink in the air ejected from the nozzle Nz. The control circuit 210 receives, from the ink jet printer 100, moving image information indicating a moving image obtained by imaging for a predetermined period of time by the imaging device. Then, the control circuit 210 receives information indicating the ejection amount and information indicating the ejection speed by analyzing the moving image information. Alternatively, the control circuit 210 may receive the moving image information itself as the characteristic information TI.

Further, in order to receive the information indicating the ejection stability, for example, the ink jet printer 100 includes an imaging device that can image the recording medium PP after the ink ejected from each of the plurality of nozzles Nz has landed. The control circuit 210 receives, from the ink jet printer 100, image information indicating an image captured by the imaging device. The control circuit 210 receives information indicating the ejection stability by analyzing the image information. Alternatively, the control circuit 210 may receive the image information itself as the characteristic information TI.

The evaluation information HI indicates, for example, an evaluation result obtained by the user U evaluating one or more evaluation items of the control information CI. The evaluation items are one or more of the following: comprehensive evaluation, print quality, waveform provision period, character rattling, and color bleeding. The comprehensive evaluation is a comprehensive evaluation regarding the recording operation. The print quality is the quality of the image formed at the recording medium PP. The waveform provision period is a period from when the user U instructs the processing apparatus 200 to receive the provision of the control information CI until the end of the ejection operation. The character rattling is the rattling of the outline of a character when the image formed at the recording medium PP includes the character. The color bleeding is a bleeding of the color of an image formed at the recording medium PP.

However, the evaluation items are not limited to the items mentioned above. For example, the evaluation item is one or more of the following: degree of graininess, degree of banding, brightness, saturation, degree of redness, degree of bluishness, and degree of greenness, instead of or in addition to the plurality of items mentioned above. The banding is a line that occurs when partial images corresponding to adjacent passes are formed.

The control circuit 210 receives the evaluation information HI when the user U operates the input device 260. For example, the control circuit 210 causes the display device 270 to display an image into which evaluation results for a plurality of evaluation items can be input. The user U operates the input device 260 while viewing the image displayed on the display device 270 to input the evaluation result.

After the processing in step SK8 ends, the control circuit 210 transmits the characteristic information TI and the evaluation information HI to the generation server CCS in step SK10.

When the characteristic information TI and the evaluation information HI are received, the generation server CCS functions as the storage section 403, and associates the characteristic information TI and the evaluation information HI with the condition information UI and stores them in the characteristic/evaluation accumulation table HDB in step SC6. In addition, the generation server CCS may store the characteristic information TI and the evaluation information HI in the characteristic/evaluation accumulation table HDB in association with the account ID of the user U. Further, the generation server CCS may store the characteristic information TI and the evaluation information HI in the characteristic/evaluation accumulation table HDB without associating them with the condition information UI. After step SC6 ends, the ink jet system 10 ends a series of processing operations shown in FIG. 11.

FIG. 14 is a diagram for describing a request to access data and an update request for a program in the ink jet system 10. The data in the ink jet system 10 shown in FIG. 14 are the account management table UDB, the control information accumulation table CDB, and the characteristic/evaluation accumulation table HDB. The programs in the ink jet system 10 shown in FIG. 14 are the accumulation program PMD and the generation program PMC. In the present embodiment, a request to access data is a general term for a data reference request, a data editing request, and a data addition request. In the present embodiment, editing the data includes updating the data and deleting the data.

As shown in FIG. 14, the accumulation server DCS can receive a data reference request from the user U. For example, it is assumed that the processing apparatus 200 has transmitted, to the accumulation server DCS, a request to refer to the user U's own account ID and e-mail address in the account management table UDB of the accumulation server DCS based on the operation of the user U. Under this assumption, the accumulation server DCS transmits the user U's own account ID and e-mail address to the processing apparatus 200 based on this request.

Further, as shown in FIG. 14, the generation server CCS rejects reception of a data reference request from the user U. For example, when the processing apparatus 200 transmits a data reference request from the user U to the generation server CCS, the generation server CCS transmits a negative response indicating that the reference request is rejected to the processing apparatus 200. Transmitting a negative response indicating that the request is rejected is an example of “not receiving the request”.

In addition, as shown in FIG. 14, the accumulation server DCS can receive a data editing request from the user U. For example, it is assumed that the processing apparatus 200 has transmitted, to the accumulation server DCS, a request to edit the user U's own e-mail address in the account management table UDB of the accumulation server DCS based on the operation of the user U. Under this assumption, the accumulation server DCS updates the e-mail address in the account management table UDB based on this request.

Further, as shown in FIG. 14, the generation server CCS rejects reception of a data editing request from the user U. For example, when the processing apparatus 200 transmits a data editing request to the generation server CCS based on the operation of the user U, the generation server CCS transmits a negative response indicating that the editing request is rejected to the processing apparatus 200.

The generation server CCS may not transmit a response to the access request instead of transmitting a negative response indicating that the access request shown in FIG. 14 is rejected. Not transmitting a response to the request is an example of “not receiving the request”.

Also, as shown in FIG. 14, the accumulation server DCS and the generation server CCS permit the reception of the data addition request from the user U. For example, when the processing apparatus 200 transmits a data addition request to the accumulation server DCS based on the operation of the user U, the accumulation server DCS adds data based on the addition request. For example, the processing of transmitting the condition information UI to the accumulation server DCS by the processing apparatus 200, which is the processing in step SK4 shown in FIG. 11, corresponds to a data addition request from the user U to the accumulation server DCS. Similarly, the processing of transmitting the characteristic information TI and the evaluation information HI to the generation server CCS, which is the processing in step SK10 shown in FIG. 11, corresponds to a data addition request from the user U to the generation server CCS.

Also, as shown in FIG. 14, the accumulation server DCS and the generation server CCS permit the reception of the data access request from an administrator. The accumulation server DCS and the generation server CCS determine, for example, whether the access request is a request from the user U or the access request is a request from an administrator, based on the login ID of the ink jet system 10.

In addition, as shown in FIG. 14, the accumulation server DCS rejects reception of an update request for the accumulation program PMD from the administrator. For example, when the administrator server 500 transmits an update request for the accumulation program PMD to the accumulation server DCS, the accumulation server DCS transmits a negative response indicating that the update request is rejected to the administrator server 500.

As a method for updating the accumulation program PMD, for example, the processing apparatus 200 stores the accumulation program PMD generated by the administrator from the administrator server 500 in the storage circuit 220 of the processing apparatus 200 based on an operation of the user U. Then, the processing apparatus 200 transmits, to the accumulation server DCS, an update request for the accumulation program PMD including the accumulation program PMD at a time convenient for the user company, for example, outside the business hours of the user company. The accumulation server DCS updates the accumulation program PMD stored in the storage circuit 320 based on the update request. More specifically, when an update request from the processing apparatus 200 is received, the accumulation server DCS ends the execution of the accumulation program PMD. Next, the accumulation server DCS updates the accumulation program PMD stored in the storage circuit 320 with the accumulation program PMD included in the update request. Then, the accumulation server DCS executes the updated accumulation program PMD.

In addition, as shown in FIG. 14, the generation server CCA permits the reception of an update request for the generation program PMC from the administrator. For example, when the administrator server 500 transmits an update request for the generation program PMC to the generation server CCS, the generation program PMC is updated based on the update request.

### 1-5. Summary of First Embodiment

A summary of the first embodiment will be described below. For ease of description, the head unit HU included in the ink jet printer 100_1 may be referred to as a head unit HU_1. Further, the condition information UI regarding the usage condition when the recording operation is executed in the ink jet printer 100_1 may be referred to as condition information UI_1. The control information CI for controlling the recording operation of the ink jet printer 100_1 based on the condition information UI_1 may be referred to as control information CI_1. Further, the characteristic information TI regarding the ejection characteristic of the head unit HU_1 when the recording operation of the ink jet printer 100_1 is executed based on the control information CI_1 may be referred to as characteristic information TI_1. Furthermore, the evaluation information HI regarding the evaluation of the user U_1 of the recording system 20_1 when the recording operation of the ink jet printer 100_1 is executed based on the control information CI_1 may be referred to as evaluation information HI_1. The head unit HU_1 is an example of a “first head unit”. The ink jet printer 100_1 is an example of a “first recording apparatus”. The processing apparatus 200_1 is an example of a “first processing apparatus”. The recording system 20_1 is an example of a “first subsystem”. The user U_1 is an example of a “first user”. The condition information UI_1 is an example of “first condition information”. The control information CI_1 is an example of “first control information”. The characteristic information TI_1 is an example of “first characteristic information”. The evaluation information HI_1 is an example of “first evaluation information”.

Further, the head unit HU included in the ink jet printer 100_2 may be referred to as a head unit HU_2. Further, the condition information UI regarding the usage condition when the recording operation is executed in the ink jet printer 100_2 may be referred to as condition information UI_2. The control information CI for controlling the recording operation of the ink jet printer 100_2 based on the condition information UI_2 may be referred to as control information CI_2. Further, the characteristic information TI regarding the ejection characteristic of the head unit HU_2 when the recording operation of the ink jet printer 100_2 is executed based on the control information CI_2 may be referred to as characteristic information TI 2. Furthermore, the evaluation information HI regarding the evaluation of the user U_2 of the recording system 20_2 when the recording operation of the ink jet printer 100_2 is executed based on the control information CI_2 may be referred to as evaluation information HI_2. The head unit HU_2 is an example of a “second head unit”. The ink jet printer 100_2 is an example of a “second recording apparatus”. The processing apparatus 200_2 is an example of a “second processing apparatus”. The recording system 20_2 is an example of a “second subsystem”. The user U_2 is an example of a “second user”. The condition information UI_2 is an example of “second condition information”. The control information CI_2 is an example of “second control information”. The characteristic information TI 2 is an example of “second characteristic information”. The evaluation information HI_2 is an example of “second evaluation information”.

The ink jet system 10 according to the first embodiment includes: the recording system 20_1 including at least the ink jet printer 100_1 and the processing apparatus 200_1, the ink jet printer 100_1 being equipped with the head unit HU_1 that ejects ink and being configured to execute a recording operation on the recording medium PP, the processing apparatus 200_1 performing data processing for causing the ink jet printer 100_1 to execute the recording operation; the recording system 20_2 including at least the ink jet printer 100_2 and the processing apparatus 200_2, the ink jet printer 100_2 being equipped with the head unit HU_2 that ejects ink and being configured to execute a recording operation on the recording medium PP, the processing apparatus 200_2 performing data processing for causing the ink jet printer 100_2 to execute the recording operation; the in-cloud server 300 that functions as the accumulation server DCS connected to both the recording system 20_1 and the recording system 20_2; and the in-cloud server 400 that functions as the generation server CCS connected to the accumulation server DCS.

According to the first embodiment, even when the generation program PMC cannot be executed due to the updating of the generation program PMC or the like, the control information CI stored in the accumulation server DCS can be provided from the accumulation server DCS. Therefore, it is possible to reduce the frequency of occurrence of a situation in which a recording operation cannot be executed, compared to the aspect in which one in-cloud server is used. Further, even when accesses are concentrated on the generation server CCS, accesses may not be concentrated on the accumulation server DCS. Therefore, according to the first embodiment, even when accesses concentrate on the generation server CCS, the processing speed of the accumulation server DCS does not decrease. Therefore, it is possible to suppress a decrease in usability. The case where the generation program PMC cannot be executed is not limited to the case where the generation program PMC is being updated. For example, the server provider may shut down the in-cloud server 400 for maintenance or the like.

In addition, the recording system 20_1 transmits the condition information UI_1 to the accumulation server DCS, when the condition information UI_1 is received, the accumulation server DCS stores the condition information UI_1, and then transmits the condition information UI_1 to the generation server CCS, when the condition information UI_1 is received, the generation server CCS generates the control information CI_1 based on the condition information UI_1, and then transmits the control information CI_1 to the accumulation server DCS, and when the control information CI_1 is received, the accumulation server DCS stores the control information CI_1, and then transmits the control information CI_1 to the recording system 20_1. Similarly, the recording system 20_2 transmits the condition information UI_2 to the accumulation server DCS, when the condition information UI_2 is received, the accumulation server DCS stores the condition information UI_2, and then transmits the condition information UI_2 to the generation server CCS, when the condition information UI_2 is received, the generation server CCS generates the control information CI_2 based on the condition information UI_2, and then transmits the control information CI_2 to the accumulation server DCS, and when the control information CI_2 is received, the accumulation server DCS stores the control information CI_2, and then transmits the control information CI_2 to the recording system 20_2.

The recording system 20 may be connected to the accumulation server DCS regardless of when a recording operation according to new condition information UI is executed or when a recording operation according to existing condition information UI is executed. Therefore, according to the first embodiment, the configuration of the recording system 20 can be simplified compared to the aspect in which the connection destination server is switched depending on when a recording operation is executed according to new condition information UI or when a recording operation is executed according to existing condition information UI.

The recording system 20_1 also transmits the characteristic information TI_1 to the generation server CCS. By referring to the characteristic information TI_1 stored in the characteristic/evaluation accumulation table HDB of the generation server CCS, the head manufacturer can provide appropriate control information CI from the next time onward. For example, it is assumed that the characteristic information TI_1 includes information indicating an ejection amount. Under this assumption, when the information indicating the ejection amount included in the characteristic information TI_1 indicates an amount smaller than that expected by the head manufacturer, the head manufacturer generates a generation program PMC that can generate control information CI that increases the ejection amount.

The recording system 20_1 also transmits the evaluation information HI_1 to the generation server CCS. By referring to the evaluation information HI_1 stored in the characteristic/evaluation accumulation table HDB of the generation server CCS, the head manufacturer can provide appropriate control information CI from the next time onward. For example, it is assumed that the evaluation information HI_1 includes evaluation of print quality and evaluation of the waveform provision period. Under this assumption, when the evaluation of the print quality included in the evaluation information HI_1 is the lowest evaluation among the five stages, the head manufacturer improves the ejection amount, the ejection speed, and the like. Further, when the evaluation of the waveform provision period included in the evaluation information HI_1 is the lowest evaluation, the head manufacturer speeds up the operation of the generation program PMC, for example.

Further, as in the present embodiment, by storing the characteristic information TI_1 and the evaluation information HI_1 in the characteristic/evaluation accumulation table HDB in association with the condition information UI, for example, when paying attention to one or both of the obtained characteristic information TI and evaluation information HI, the head manufacturer can reproduce the usage conditions of the head unit HU of the user U based on the condition information UI.

In addition, the condition information UI_1 may include information regarding the type of ink ejected by the head unit HU_1.

As described above, the ejection amount of the ink may fluctuate depending on the type of ink. Since the condition information UI includes the information regarding the type of ink, the generation server CCS can generate control information CI that cancels the fluctuation in the ejection amount depending on the type of ink.

Furthermore, the condition information UI_1 may include information regarding the type of the recording medium PP on which the ink jet printer 100_1 executes the recording operation.

As described above, the state of the ink after the ink lands on the recording medium PP may fluctuate depending on the type of the recording medium PP. Since the condition information UI includes the information regarding the type of the recording medium PP, the generation server CCS can generate control information CI that cancels the fluctuation in the state of ink depending on the type of the recording medium PP.

Furthermore, the condition information UI_1 may include information regarding the temperature of the head unit HU_1 in the usage environment of the recording system 20_1.

As described above, the ejection amount of the ink may fluctuate depending on the environmental temperature. Since the condition information UI includes the information regarding the environmental temperature, the generation server CCS can generate control information CI that cancels the fluctuation in the ejection amount of the ink depending on the environmental temperature.

Furthermore, the head unit HU_1 includes the drive element 111f that is a piezoelectric element, and the control information CI_1 includes information regarding the drive signal Com to be applied to the drive element 111f.

According to the first embodiment, the generation server CCS transmits the information regarding the drive signal Com to the recording system 20, and therefore, the recording system 20 can execute the ejection operation according to the usage conditions of the head unit HU.

In addition, the accumulation server DCS can receive a request from the user U_1 to refer to data in the accumulation server DCS and a request from the user U_2 to refer to data in the accumulation server DCS, and the generation server CC rejects reception of a request from the user U_1 to refer to data in the generation server CCS and a request from the user U_2 to refer to data in the generation server CCS.

According to the first embodiment, since the generation server CCS does not receive a request from the user U to refer to data, compared to the aspect in which the generation server CCS can receive a request from the user U to refer to data, the processing load on the generation server CCS can be suppressed from increasing.

In addition, the accumulation server DCS can receive a request from the user U_1 to update data in the accumulation server DCS and a request from the user U_2 to update data in the accumulation server DCS, and the generation server CC rejects reception of a request from the user U_1 to update data in the generation server CCS and a request from the user U_2 to update data in the generation server CCS.

According to the first embodiment, since the generation server CCS does not receive a request from the user U to update data, compared to the aspect in which the generation server CCS can receive a request from the user U to update data, the processing load on the generation server CCS can be suppressed from increasing.

In addition, the accumulation server DCS can receive a request from the user U_1 to add data into the accumulation server DCS and a request from the user U_2 to add data into the accumulation server DCS, and the generation server CC can receive a request from the user U_1 to add data into the generation server CCS and a request from the user U_2 to add data into the generation server CCS.

According to the first embodiment, the recording system 20 can issue a request to add data from the user U to both the accumulation server DCS and the generation server CCS. Therefore, the recording system 20 can appropriately transmit data to the accumulation server DCS and the generation server CCS depending on the type of data. For example, since the characteristic information TI and the evaluation information HI are information required by the head manufacturer, the recording system 20 transmits the characteristic information TI and the evaluation information HI to the generation server CCS as in step SK10.

Further, the generation server CCS can receive a request from the administrator to update the generation program PMC, which is a program of the generation server CCS.

According to the first embodiment, even while the generation program PMC is being updated, the recording system 20 can acquire the control information CI from the accumulation server DCS, and thus it is possible to reduce the frequency of occurrence of a situation in which the recording operation cannot be executed.

The accumulation server DCS rejects reception of a request from the administrator to update the accumulation program PMD, which is a program of the accumulation server DCS.

According to the first embodiment, since the accumulation server DCS rejects the reception of the update request for the accumulation program PMD from the administrator, when a user company wants to execute a recording operation, it is possible to avoid a situation in which the control information CI cannot be acquired from the accumulation server DCS due to updating the accumulation program PMD.

### 2. Second Embodiment

In the ink jet system 10 according to the first embodiment, when a recording operation according to new condition information UI is executed, the recording system 20 transmits the condition information UI to the accumulation server DCS. On the other hand, in an ink jet system 10A according to a second embodiment, when a recording operation according to new condition information UI is executed, the recording system 20 transmits the condition information UI to the generation server CCS. The second embodiment will be described below.

### 2-1. Functions of Ink Jet System 10A According to Second Embodiment

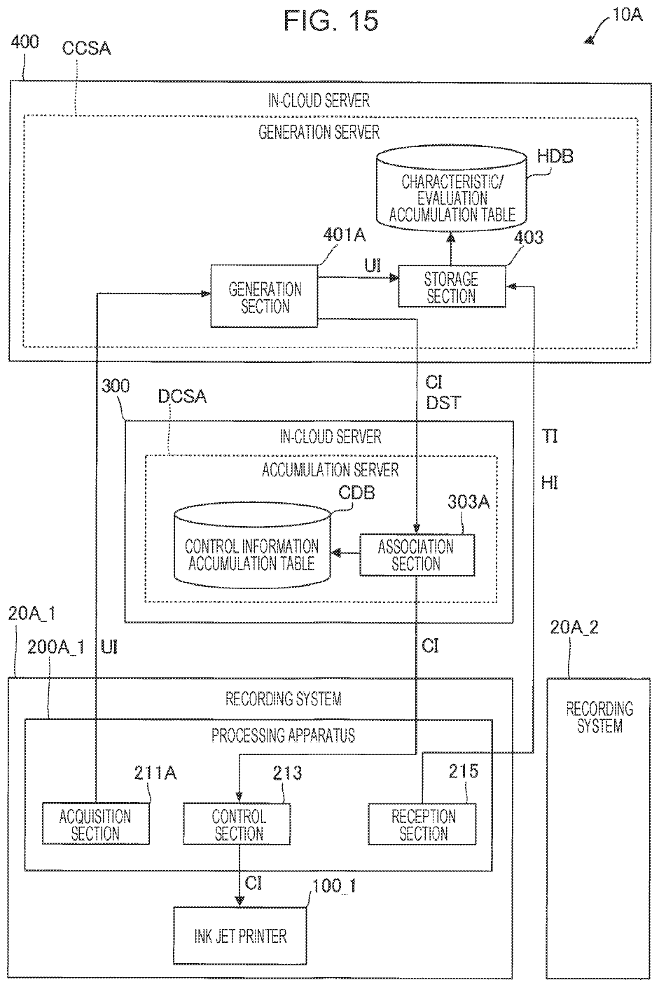

FIG. 15 is a diagram showing functions of an ink jet system 10A according to the second embodiment. The ink jet system 10A is different from the ink jet system 10 in that it includes a recording system 20A instead of the recording system 20, the in-cloud server 300 functions as an accumulation server DCSA instead of the accumulation server DCS, and the in-cloud server 400 functions as a generation server CCSA instead of the generation server CCS.

The recording system 20A is different from the recording system 20 in that it functions as an acquisition section 211A instead of the acquisition section 211. In the example of FIG. 15, a processing apparatus 200_1 included in a recording system 20A_1 functions as an acquisition section 211A, and the acquisition section 211A transmits the condition information UI to the generation server CCSA.

The generation server CCSA is different from the generation server CCS in that it functions as a generation section 401A instead of the generation section 401. When the condition information UI is received from the recording system 20A, the generation section 401A generates control information CI based on the condition information UI. Then, the generation section 401A transmits the control information CI, the condition information UI, and destination information DST to the accumulation server DCSA. The destination information DST is information indicating that a destination of the control information CI is the recording system 20_1. Specifically, the destination information DST is the IP address of the processing apparatus 200_1 that is the transmission source of the condition information UI. The generation section 401A specifies the IP address of the processing apparatus 200_1 from the transmission source IP address of the IP packet including the condition information UI. Alternatively, when the condition information UI is transmitted from the mobile terminal 700, since it is desired to transmit the control information CI to the processing apparatus 200, for example, the account management table UDB includes the IP address of the processing apparatus 200 that is the destination of the control information CI in association with the account ID. Then, the generation section 401A refers to the account management table UDB and generates the IP address associated with the account ID of the user U as the destination information DST.

The accumulation server DCSA is different from the accumulation server DCS in that it does not function as the first transfer section 301 and functions as an association section 303A instead of the association section 303. When the control information CI, the condition information UI, and the destination information DST are received, the association section 303A stores the control information CI and the condition information UI in the control information accumulation table CDB in association with each other. After storing the control information CI and the condition information UI, the association section 303A transmits the control information CI to a processing apparatus 200A 1 of the recording system 20A_1 indicated by the destination information DST.

### 2-2. Summary of Second Embodiment

A summary of the second embodiment will be described below. For ease of description, the wording defined in the summary of the first embodiment described above may be used. Further, when the recording system 20A_1 transmits the condition information UI_1 to the generation server CCSA, the destination information DST indicating that the destination of the control information CI_1 is the recording system 20A_1 may be referred to as destination information DST_1. Moreover, when a recording system 20A_2 transmits the condition information UI_2 to the generation server CCSA, the destination information DST indicating that the destination of the control information CI_2 is the recording system 20A_2 may be referred to as destination information DST_2. The destination information DST_1 is an example of “first destination information”. The destination information DST_2 is an example of “second destination information”.

The generation server CCSA is further connected to both the recording system 20A_1 and the recording system 20A_2, the recording system 20A_1 transmits the condition information UI_1 to the generation server CCSA, when the condition information UI_1 is received, the generation server CCSA generates the control information CI_1 based on the condition information UI_1, and then transmits the control information CI_1, the condition information UI_1, and the destination information DST_1 to the accumulation server DCSA, and when the control information CI_1, the condition information UI_1, and the destination information DST_1 are received, the accumulation server DCSA stores the control information CI_1 and the condition information UI_1, and then transmits the control information CI_1 to the recording system 20_1 indicated by the destination information DST_1. The recording system 20A_2 transmits the condition information UI_2 to the generation server CCSA, when the condition information UI_2 is received, the generation server CCSA generates the control information CI_2 based on the condition information UI_2, and then transmits the control information CI_2, the condition information UI_2, and the destination information DST_2 to the accumulation server DCSA, and when the control information CI_2, the condition information UI_2, and the destination information DST_2 are received, the accumulation server DCSA stores the control information CI_2 and the condition information UI_2, and then transmits the control information CI_2 to the recording system 20_2 indicated by the destination information DST_2.

In the second embodiment, when a recording operation according to new condition information UI is executed, the recording system 20A may not transfer the condition information UI to the accumulation server DCSA to the generation server CCSA. Therefore, according to the second embodiment, the processing load of the accumulation server DCSA can be reduced compared to the first embodiment.

### 3. Modification Example

Each form exemplified above can be variously modified. A specific aspect of modification is exemplified below. Any two or more aspects selected from the following examples can be combined as appropriate as long as there is no contradiction.

### 3-1. First Modification Example

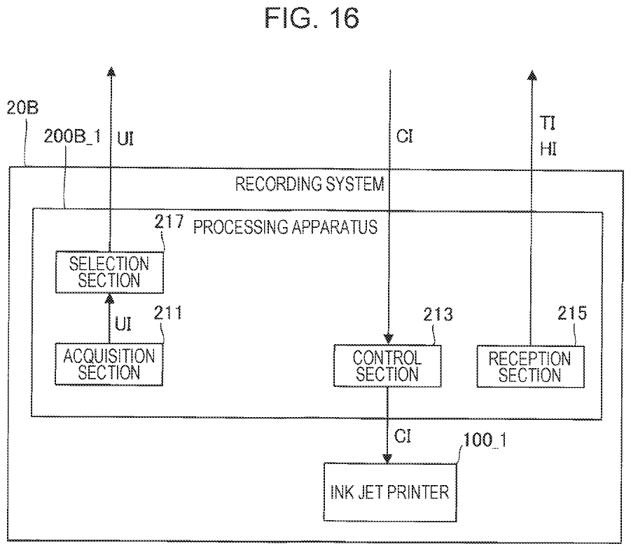

It may be possible to switch between the first embodiment and the second embodiment described above. An aspect that can be switched between the first embodiment and the second embodiment will be described with reference to FIG. 16.

FIG. 16 is a diagram showing functions of a recording system 20B according to a first modification example. A processing apparatus 200B 1 in the recording system 20B is different from the recording system 20 in that it functions as a selection section 217 in addition to the acquisition section 211, the control section 213, and the reception section 215.

The selection section 217 causes the user U to select to which of the accumulation server DCS and the generation server CCS the condition information UI acquired by the acquisition section 211 is to be transmitted. In this way, in the first modification example, the user U can select to which of the accumulation server DCS and the generation server CCS the condition information UI is to be transmitted. For example, the control circuit 210 causes the display device 270 to display an image for selecting to which of the accumulation server DCS and the generation server CCS the condition information UI is to be transmitted. The user U refers to an image displayed on the display device 270 and selects either the accumulation server DCS or the generation server CCS. The selection section 217 transmits the condition information UI to the selected server.

When the accumulation server DCS is selected, the configuration is the same as that of the first embodiment. In the following description, for ease of description, the wording defined in the summary of the first embodiment and the summary of the second embodiment described above may be used. In a case in which the accumulation server DCS is selected, when the condition information UI_1 is received from the recording system 20_1, the accumulation server DCS transmits the condition information UI_1 to the generation server CCS, when the condition information UI_1 is received, the generation server CCS generates the control information CI_1 based on the condition information UI_1, and then transmits the control information CI_1 to the accumulation server DCS, and when the control information CI_1 is received, the accumulation server DCS stores the control information CI_1, and then transmits the control information CI_1 to the recording system 20B_1.

On the other hand, in a case in which the generation server CCS is selected, when the condition information UI_1 is received, the generation server CCS generates the control information CI_1 based on the condition information UI_1, and then transmits the control information CI_1, the condition information UI_1, and the destination information DST_1 to the accumulation server DCS, and when the control information CI_1, the condition information UI_1, and the destination information DST_1 are received, the accumulation server DCS stores the control information CI_1 and the condition information UI_1, and then transmits the control information CI_1 to the recording system 20_1 indicated by the destination information DST_1.

According to the first modification example, the first embodiment and the second embodiment can be switched according to the user U's selection. For example, in the second embodiment, since the processing load of the accumulation server DCSA can be reduced as compared to the first embodiment, when the user U selects to transmit the condition information UI to the generation server CCS, the processing load on the accumulation server DCSA can be reduced. Further, when the condition information UI is transmitted to the generation server CCS, in order to prevent the condition information UI from being acquired by a malicious third party, there are situations in which it is desired to encrypt and transmit the condition information UI. Under this situation, it is assumed that the in-cloud server 300 and the recording system 20 are coupled via a dedicated line. Under this assumption, when the condition information UI is transmitted from the recording system 20 to the accumulation server DCS, the condition information UI does not need to be encrypted. Therefore, by selecting to transmit the condition information UI to the accumulation server DCS, the user U can reduce the processing load on the recording system 20 because the recording system 20 does not have to perform encryption processing.

### 3-2. Second Modification Example

In the first embodiment described above, the accumulation server DCS is implemented by the in-cloud server 300, but the present disclosure is not limited thereto.

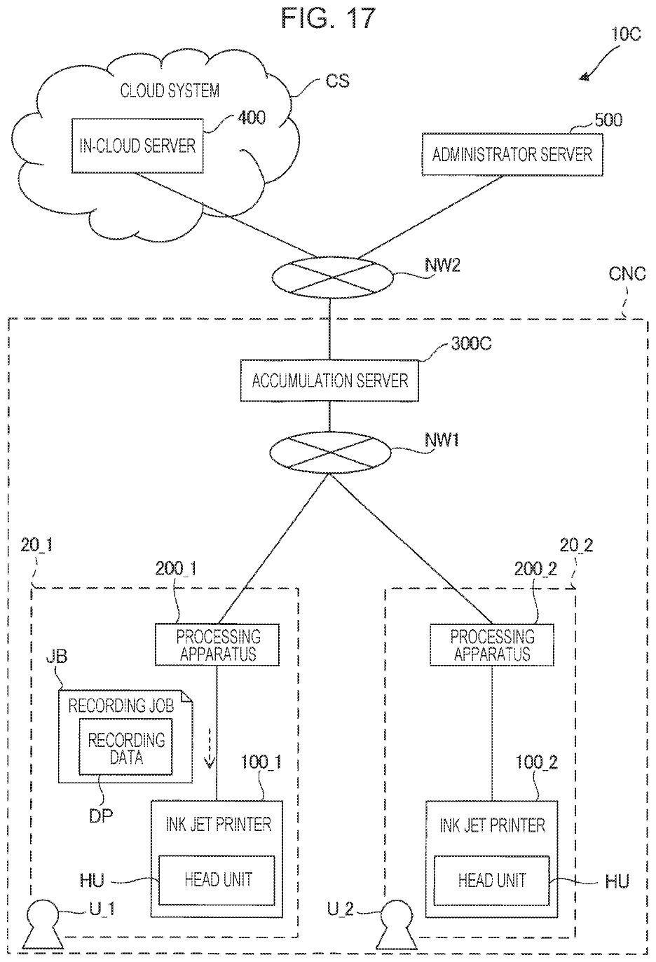

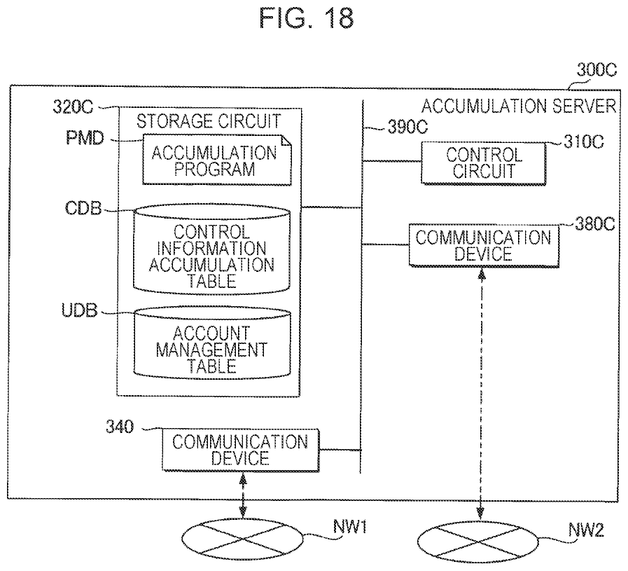

FIG. 17 is a schematic diagram showing a configuration example of an ink jet system 10C according to a second modification example. The ink jet system 10C is different from the ink jet system 10 in that it includes an accumulation server 300C instead of the in-cloud server 300 and includes an in-house system CNC instead of the in-house system CN.

The accumulation server 300C is a physical server and is included in the in-house system CN. The accumulation server 300C is a so-called on-premises server. On-premises servers are servers that are installed and operated within facilities managed by a company. In the second modification example, the accumulation server 300C is an example of a “first server”.

The in-house system CNC is different from the in-house system CN in that it includes the accumulation server 300C in addition to the processing apparatuses 200_1 and 200_2. In the second modification example, the processing apparatus 200_1, the processing apparatus 200_2, and the accumulation server 300C are communicatively connected to each other via a network NW1 such as a LAN. LAN is an abbreviation for Local Area Network. The in-cloud server 400, the accumulation server 300C, and the administrator server 500 are communicatively connected to each other via a network NW2 such as a WAN and the Internet.

As can be understood from FIG. 17, the recording system 20 is not connected to the in-cloud server 400 and the administrator server 500. When the recording system 20 transmits the data to the in-cloud server 400 or the administrator server 500, the data passes through the accumulation server 300C.

FIG. 18 is a diagram showing an example of a configuration of the accumulation server 300C. The accumulation server 300C includes a control circuit 310C, a storage circuit 320C, a communication device 340, and a communication device 380C. The control circuit 310C, the storage circuit 320C, the communication device 340, and the communication device 380C are coupled to one another via a bus 390C for communicating information.

The control circuit 310C includes, for example, one or more processors such as CPUs. The control circuit 310C may include a programmable logic device such as an FPGA instead of or in addition to the CPU.

The storage circuit 320C is composed of a magnetic storage device, a flash ROM, or the like. The storage circuit 320C is readable by the control circuit 310C, and stores a plurality of programs including an accumulation program PMD executed by the control circuit 310C, a control information accumulation table CDB, an account management table UDB, various types of information used by the control circuit 310C, and the like.

The communication device 340 is hardware having a communication circuit for communicating with other devices such as the processing apparatus 200 via the network NW1.

The communication device 380C is hardware having a communication circuit for communicating with other devices such as the in-cloud server 400, the processing apparatus 200, and the administrator server 500 via the network NW2. The communication device 340 and the communication device 380C may be one piece of hardware.

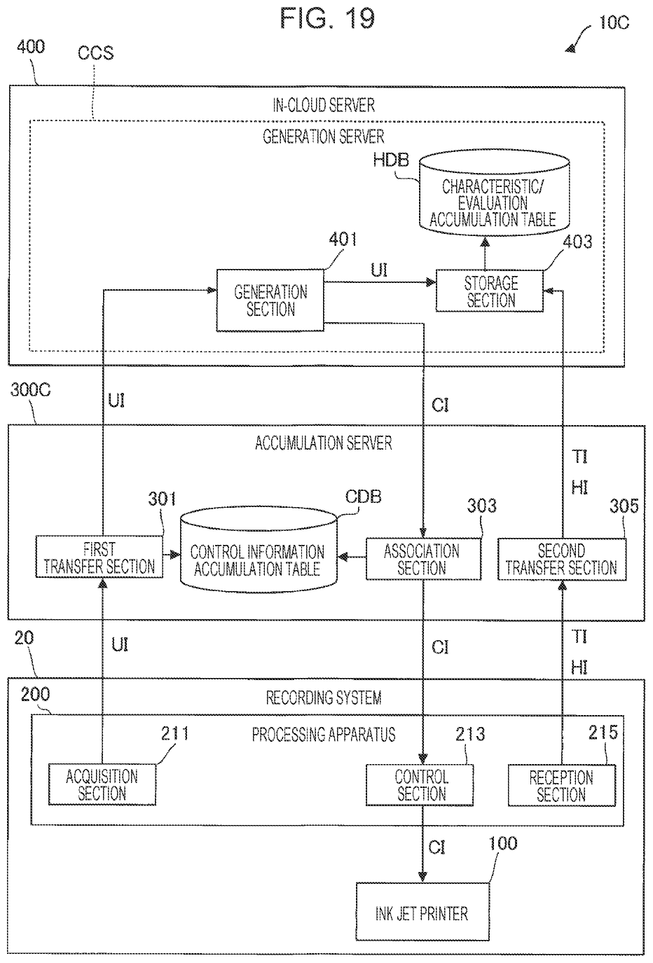

FIG. 19 is a diagram showing functions of the ink jet system 10C. The accumulation server 300C functions as the first transfer section 301, the association section 303, and the second transfer section 305 by reading the accumulation program PMD and executing the accumulation program PMD.

The reception section 215 transmits the characteristic information TI and the evaluation information HI to the accumulation server DCS. When the characteristic information TI and the evaluation information HI are received, the second transfer section 305 transmits the characteristic information TI and the evaluation information HI to the generation server CCS.

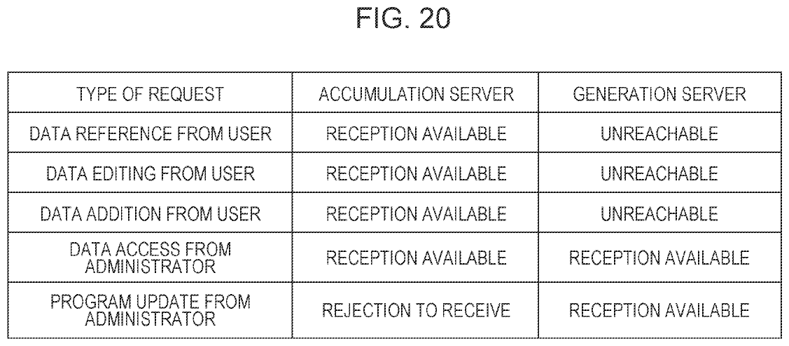

FIG. 20 is a diagram for describing a request to access data in the ink jet system 10C and a request to update a program. The change from the ink jet system 10 is an access request for the data made by the user U to the generation server CCS.

In the second modification example, even when the user U attempts to transmit a data reference request, a data editing request, and a data addition request to the generation server CCS, the accumulation server 300C rejects each request. Therefore, the data reference request, data editing request, and data addition request from the user U do not reach the generation server CCS. The request not reaching is an example of “does not receive a request”.

### 3-3. Third Modification Example

The ink jet system 10 according to each of the above-described aspects includes one accumulation server DCS, but may include a plurality of accumulation servers DCS.

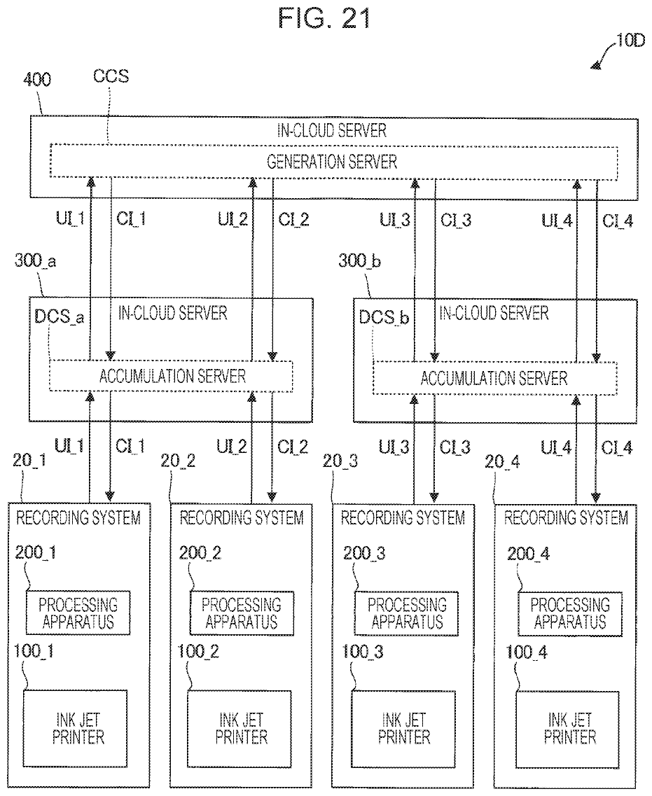

FIG. 21 is a diagram showing functions of an ink jet system 10D according to a third modification example. In FIG. 21, in order to prevent the drawing from being complicated, the description that the recording system 20 transmits the characteristic information TI and the evaluation information HI is omitted.

The ink jet system 10D includes two in-cloud servers 300: an in-cloud server 300_a and an in-cloud server 300_b, as servers that function as the accumulation server DCS, and includes four recording systems 20: a recording system 20_1, a recording system 20_2, a recording system 20_3, and a recording system 20_4. However, the number of the in-cloud servers 300 included in the ink jet system 10D that functions as the accumulation server DCS is two in the example shown in FIG. 21, but may be three or more. The generation server CCS is connected to the in-cloud server 300_a and the in-cloud server 300_b.

The in-cloud server 300_a functions as a plurality of virtual servers, and one virtual server among the plurality of virtual servers executes the accumulation program PMD. The virtual server that executes the accumulation program PMD will hereinafter be referred to as an accumulation server DCS_a. Further, the in-cloud server 300_b functions as a plurality of virtual servers, and one virtual server among the plurality of virtual servers executes the accumulation program PMD. The virtual server that executes the accumulation program PMD will hereinafter be referred to as an accumulation server DCS_b. In the third modification example, the in-cloud server 300_a is an example of a “first server”, and the in-cloud server 300_b is an example of a “third server”.

The in-cloud server 300_a is connected to both the recording system 20_1 and the recording system 20_2. The in-cloud server 300_b is also connected to both the recording system 20_1 and the recording system 20_2.

Hereinafter, for ease of description, the wording defined in the summary of the first embodiment described above may be used. Further, the head unit HU included in an ink jet printer 100_3 in the recording system 20_3 may be referred to as a head unit HU 3. Further, the condition information UI regarding the usage condition when the recording operation is executed in the ink jet printer 100_3 may be referred to as condition information UI_3. The control information CI for controlling the recording operation of the ink jet printer 100_3 based on the condition information UI_3 may be referred to as control information CI_3. The head unit HU included in an ink jet printer 100_4 in the recording system 20_4 may be referred to as a head unit HU_4. Further, the condition information UI regarding the usage condition when the recording operation is executed in the ink jet printer 100_4 may be referred to as condition information UI_4. The control information CI for controlling the recording operation of the ink jet printer 100_4 based on the condition information UI_4 may be referred to as control information CI 4.

The recording system 20_1 transmits the condition information UI_1 to the accumulation server DCS_a. When the condition information UI_1 is received, the accumulation server DCS_a stores the condition information UI_1 in the control information accumulation table CDB and transmits the condition information UI_1 to the accumulation server DCS_a. When the condition information UI_1 is received, the generation server CCS generates the control information CI_1 based on the condition information UI_1 and transmits the control information CI_1 to the accumulation server DCS_a. When the control information CI_1 is received, the accumulation server DCS_a stores the control information CI_1 in the control information accumulation table CDB and transmits the control information CI_1 to the recording system 20_1.

The recording system 20_2 transmits the condition information UI_2 to the accumulation server DCS_a. When the condition information UI_2 is received, the accumulation server DCS_a stores the condition information UI_2 in the control information accumulation table CDB and transmits the condition information UI_2 to the accumulation server DCS_a. When the condition information UI_2 is received, the generation server CCS generates the control information CI_2 based on the condition information UI_2 and transmits the control information CI_2 to the accumulation server DCS_a. When the control information CI_2 is received, the accumulation server DCS_a stores the control information CI_2 in the control information accumulation table CDB and transmits the control information CI_2 to the recording system 20_2.

The recording system 20_3 transmits the condition information UI_3 to the accumulation server DCS_b. When the condition information UI_3 is received, the accumulation server DCS_b stores the condition information UI_3 in the control information accumulation table CDB and transmits the condition information UI_3 to the accumulation server DCS_b. When the condition information UI_3 is received, the generation server CCS generates the control information CI_3 based on the condition information UI_3 and transmits the control information CI_3 to the accumulation server DCS_b. When the control information CI_3 is received, the accumulation server DCS_b stores the control information CI_3 in the control information accumulation table CDB and transmits the control information CI_3 to the recording system 20_3.

The recording system 20_4 transmits the condition information UI_4 to the accumulation server DCS_b. When the condition information UI_4 is received, the accumulation server DCS_b stores the condition information UI_4 in the control information accumulation table CDB and transmits the condition information UI_4 to the accumulation server DCS_b. When the condition information UI_4 is received, the generation server CCS generates the control information CI 4 based on the condition information UI_4 and transmits the control information CI 4 to the accumulation server DCS_b. When the control information CI 4 is received, the accumulation server DCS_b stores the control information CI 4 in the control information accumulation table CDB and transmits the control information CI 4 to the recording system 20_4.

Hereinafter, the ink jet system 10D according to the third modification example further includes the recording system 20_3 including at least the ink jet printer 100_3 and the processing apparatus 200_3, the ink jet printer 100_3 being equipped with the head unit HU 3 that ejects ink and being configured to execute a recording operation on the recording medium PP, the processing apparatus 200_3 performing data processing for causing the ink jet printer 100_3 to execute the recording operation; and the in-cloud server 300_b that functions as the accumulation server DCS_b connected to the recording system 20_3, and the generation server CCS is further connected to the in-cloud server 300_b. The head unit HU 3 is an example of a “third head unit”. The ink jet printer 100_3 is an example of a “third recording apparatus”. The processing apparatus 200_3 is an example of a “third processing apparatus”. The recording system 20_3 is an example of a “third subsystem”.

According to the third modification example, the ink jet system 10D includes a plurality of accumulation servers DCS, and thus the load of the accumulation server DCS can be distributed.

### 3-4. Fourth Modification Example

As described above, the control information CI may be information regarding image processing. The information regarding the image processing is, for example, information indicating a portion or all of a lookup table used in color conversion processing included in the image processing, information indicating a portion or all of a dither pattern used in RIP processing included in the image processing, and information indicating a portion or all of an error diffusion matrix used in RIP processing included in image processing. Hereinafter, a fourth modification example will be described assuming that information regarding the image processing is a lookup table.

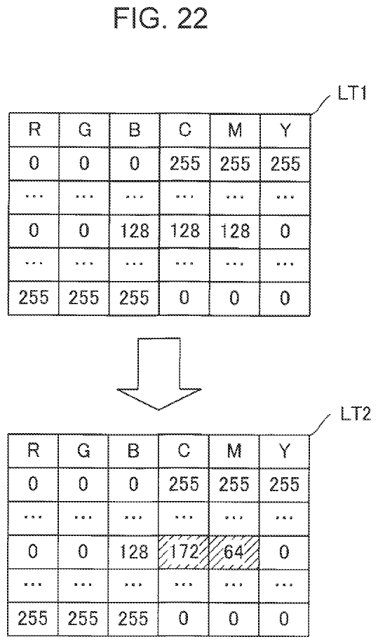

FIG. 22 is a diagram for describing an example of the control information CI according to the fourth modification example. FIG. 22 shows a lookup table LT1 which is an initial value of the ink jet program PM3 and a lookup table LT2 which is the control information CI according to the fourth modification example. The difference between the lookup table LT1 and the lookup table LT2 is that the CMY values after conversion of (R, G, B)=(0, 0, 128) are changed from (C, M, Y)=(128, 128, 0) to (C, M, Y)=(172, 64, 0).

By changing the lookup table, the ink jet system 10 according to the fourth modification example can execute the ejection operation according to the usage conditions of the head unit HU, similarly to the first embodiment. For example, when the ejection amount decreases depending on the usage conditions of the head unit HU, one or more of the CMY values may be increased. For example, it is assumed that the information included in the condition information UI is information indicating the viscosity of the ink, and the viscosity is higher than a general viscosity. Based on this assumption, the generation section 401 generates a lookup table so as to increase one or more of the CMY values. Even when the information included in the condition information UI is any one or more of information regarding the type of the head unit HU, information regarding the type of the recording medium PP, and information regarding temperature, it can be applied in the same way as information regarding the type of ink.

Regarding the series of operations of the ink jet system 10 according to the fourth modification example, in step SK6, the control circuit 210 receives the lookup table LT2, which is the control information CI according to the fourth modification example, and overwrites the lookup table LT1 stored in the storage circuit 220 with the lookup table LT2.

The processing apparatus 200_1 generates recording data DP used for recording by executing image processing on image data as data processing, and transmits the recording data DP to the ink jet printer 100_1, the ink jet printer 100_1 executes a recording operation based on the recording data DP, and the control information CI_1 includes information regarding image processing.

With the ink jet system 10 according to the fourth modification example, the accumulation server DCS transmits information regarding image processing to the recording system 20, and therefore, the recording system 20 can execute the ejection operation according to the usage conditions of the head unit HU. Compared to the first embodiment, in the fourth modification example, fine adjustment of the drive signal Com is not required. Therefore, in the ink jet system 10 according to the fourth modification example, the drive element 111f may be a heating element. The heating element converts electrical energy into thermal energy, generates air bubbles inside the pressure chamber CV by heating, and fluctuates a pressure inside the pressure chamber CV.

### 3-5. Fifth Modification Example

In each of the above-described aspects, when the ink jet printer 100 includes an input device and a display device, and functions as the acquisition section 211, the control section 213, and the reception section 215, the control circuit 170 functions as the acquisition section 211, the control section 213, and the reception section 215, but the present disclosure is not limited thereto. For example, when the head unit HU includes a control circuit such as a CPU, the control circuit may function as the acquisition section 211, the control section 213, and the reception section 215.

### 3-6. Sixth Modification Example

In each of the above-described aspects, when the ink jet printer 100 is connectable to the network NW, the communication device 150 is connected to the network NW, but the present disclosure is not limited thereto. For example, when the head unit HU has a communication device, the communication device may communicate with the network NW.

### 3-7. Seventh Modification Example

In each of the above-described aspects, the recording system 20 transmits the characteristic information TI and the evaluation information HI to the generation server CCS, but may not transmit one or both of the characteristic information TI and the evaluation information HI to the generation server CCS.

### 3-8. Eighth Modification Example

In each of the above-described aspects, the generation server CCS may receive a request from the user U to refer to the data in the generation server CCS. In addition, the generation server CCS may receive a request from the user U to update the data in the generation server CCS. A request from the administrator to update the accumulation program PMD, which is a program of the accumulation server DCS, may be received.

### 3-9. Ninth Modification Example

In each of the above-described aspects, the serial type ink jet printer 100 in which the head unit HU is reciprocated in the direction along the X-axis has been exemplified, but the present disclosure is not limited to such an aspect. The ink jet printer 100 may be a line type liquid ejecting apparatus in which a plurality of nozzles Nz are distributed over the entire width of the recording medium PP.

### 3-10. Other Modification Examples

The above-described ink jet printer 100 can be employed in various devices such as a facsimile machine and a copier, in addition to a device dedicated to printing. However, the application of use of the recording apparatus of the present disclosure is not limited to printing. For example, a recording apparatus that ejects a solution of a coloring material is used as a manufacturing device forming a color filter of a liquid crystal display device. In addition, a recording apparatus that ejects a solution of a conductive material is used as a manufacturing device for forming wiring and electrodes of a wiring substrate.

What is claimed is:

1. An ink jet system comprising:
a first subsystem including at least a first recording apparatus and a first processing apparatus, the first recording apparatus being equipped with a first head unit that ejects ink and being configured to execute a recording operation on a recording medium, the first processing apparatus performing data processing for causing the first recording apparatus to execute the recording operation;
a second subsystem including at least a second recording apparatus and a second processing apparatus, the second recording apparatus being equipped with a second head unit that ejects ink and being configured to execute a recording operation on a recording medium, the second processing apparatus performing data processing for causing the second recording apparatus to execute the recording operation;
a first server connected to both the first subsystem and the second subsystem; and
a second server connected to the first server.

2. The ink jet system according to claim 1, wherein
the first subsystem transmits, to the first server, first condition information regarding a usage condition when a recording operation is executed in the first recording apparatus,
when the first condition information is received, the first server stores the first condition information, and then transmits the first condition information to the second server,
when the first condition information is received, the second server generates first control information for controlling the recording operation of the first recording apparatus based on the first condition information, and then transmits the first control information to the first server, and
when the first control information is received, the first server stores the first control information, and then transmits the first control information to the first subsystem.

3. The ink jet system according to claim 1, wherein
the second server is further connected to both the first subsystem and the second subsystem,
the first subsystem transmits, to the second server, first condition information regarding a usage condition when a recording operation of the first recording apparatus is executed,
when the first condition information is received, the second server generates first control information for controlling the recording operation of the first recording apparatus based on the first condition information, and then transmits, to the first server, the first control information, the first condition information, and first destination information indicating that a destination of the first control information is the first subsystem, and
when the first control information, the first condition information, and the first destination information are received, the first server stores the first control information and the first condition information, and then transmits the first control information to the first subsystem indicated by the first destination information.

4. The ink jet system according to claim 1, wherein
the second server is further connected to both the first subsystem and the second subsystem,
the first subsystem is configured such that a user selects to which of the first server and the second server first condition information regarding a usage condition when a recording operation of the first recording apparatus is executed is to be transmitted, and transmits the first condition information to the selected server,
in a case in which the first server is selected,
when the first condition information is received from the first subsystem, the first server transmits the first condition information to the second server,
when the first condition information is received, the second server generates first control information for controlling the recording operation of the first recording apparatus based on the first condition information, and then transmits the first control information to the first server, and
when the first control information is received, the first server stores the first control information, and then transmits the first control information to the first subsystem, and
in a case in which the second server is selected,
when the first condition information is received, the second server generates the first control information based on the first condition information, and then transmits, to the first server, the first control information, the first condition information, and first destination information indicating that a destination of the first control information is the first subsystem, and
when the first control information, the first condition information, and the first destination information are received, the first server stores the first control information and the first condition information, and then transmits the first control information to the first subsystem indicated by the first destination information.

5. The ink jet system according to claim 2, wherein
the first subsystem transmits, to the second server, first characteristic information regarding an ejection characteristic of the first head unit when the recording operation of the first recording apparatus is executed based on the first control information.

6. The ink jet system according to claim 2, wherein
the first subsystem transmits, to the second server, first evaluation information regarding an evaluation of a user of the first subsystem when the recording operation of the first recording apparatus is executed based on the first control information.

7. The ink jet system according to claim 2, wherein
the first condition information includes information regarding a type of ink ejected by the first head unit.

8. The ink jet system according to claim 2, wherein
the first condition information includes information regarding a type of recording medium on which the first recording apparatus executes the recording operation.

9. The ink jet system according to claim 2, wherein
the first condition information includes information regarding a temperature of the first head unit in a usage environment of the first subsystem.

10. The ink jet system according to claim 2, wherein
the first head unit includes a drive element, and
the first control information includes information regarding a drive signal to be applied to the drive element.

11. The ink jet system according to claim 2, wherein
the first processing apparatus generates recording data to be used for recording by executing image processing on image data as the data processing, and transmits the recording data to the first recording apparatus,
the first recording apparatus executes the recording operation based on the recording data, and
the first control information includes information regarding the image processing.

12. The ink jet system according to claim 1, wherein
the first server is configured to receive a request from a first user of the first subsystem to refer to data in the first server, and a request from a second user of the second subsystem to refer to data in the first server, and
the second server does not receive a request from the first user to refer to data in the second server, and a request from the second user to refer to data in the second server.

13. The ink jet system according to claim 1, wherein
the first server is configured to receive a request from a first user of the first subsystem to edit data in the first server, and a request from a second user of the second subsystem to edit data in the first server, and
the second server does not receive a request from the first user to edit data in the second server, and a request from the second user to edit data in the second server.

14. The ink jet system according to claim 1, wherein
the first server is configured to receive a request from a first user of the first subsystem to add data into the first server, and a request from a second user of the second subsystem to add data into the first server, and
the second server is configured to receive a request from the first user to add data into the second server, and a request from the second user to add data into the second server.

15. The ink jet system according to claim 1, wherein
the second server is configured to receive a request from an administrator of the ink jet system to update a program of the second server.

16. The ink jet system according to claim 1, wherein
the first server does not receive a request from an administrator of the ink jet system to update a program of the first server.

17. The ink jet system according to claim 1, further comprising:
a third subsystem including at least a third recording apparatus and a third processing apparatus, the third recording apparatus being equipped with a third head unit that ejects ink and being configured to execute a recording operation on a recording medium, the third processing apparatus performing data processing for causing the third recording apparatus to execute the recording operation; and
a third server connected to the third subsystem, wherein
the second server is further connected to the third server.
